(19) United States
(12) Patent Application Publication
(10) Pub. No.: US 2009/0157507 A1
(43) Pub. Date: Jun. 18, 2009

(54) System and method to monetize the referral of web pages

(75) Inventors: Brenda Agius, Fort Myers, FL (US); Ryan J. Stephens, Naples, FL (US); Peter Weinberg, Fort Myers, FL (US)

Correspondence Address: TIMOTHY P. O'HAGAN, 8710 KILKENNY CT, FORT MYERS, FL, 33912, US

(73) Assignee: Slingpage, Inc., Estero, FL (US)

(21) Appl. No.: 12/150,243

(22) Filed: Apr. 26, 2008

Related U.S. Application Data
(63) Continuation-in-part of application No. 12/002,441, filed on Dec. 17, 2007.

(51) Int. Cl. G06Q 30/00

(52) U.S. Cl. 705/14

(57) ABSTRACT

A system and method for monetizing the referral of web pages comprises a source client system, at least one target client system, a referral server, and an accounting server. The source client system comprises a web browser adapted to render an advertising merchant's web page. A source referral module is coupled to the source web browser and, in response to user selection of at least one target client, generates a referral message to the referral server. The referral server in turn provides a provide a referral instruction to a target client system. The target client system includes a referral module receiving the referral message and upon the target client accepting the referral message, passes identification of the advertising merchant's web page to a target web browser for rendering. The target client system further generates an informational message upon the execution of a revenue event by the target client system. The accounting server, in response to receipt of the informational message: i) debits at least a referral fee from an account associated with the advertising merchant's web page; and ii) credits the referral fee to an account associated with the referral server providing the referral instruction.

### RELATION TO OTHER APPLICATIONS

The present application is a Continuation in Part of Co-pending application Ser. No. 12/002,441 filed on Dec. 17, 2007.

### TECHNICAL FIELD

The present invention relates to a system and method for monetizing the referral of web pages amounts at least two individuals, each of which operates a distinct browser.

### BACKGROUND OF THE INVENTION

Web browser systems and their operation are well known. In general, a web browser accepts input of a universal resource locator (URL) and, in response thereto, interfaces with local lower level IP service and networking systems to: i) initiate a domain name server (DNS) inquiry to a domain name server to obtain an IP address associated with input URL; and ii) initiate a TCP/IP connection with a web server at such IP address. In response, the web server provides a web document object for rendering by the browser.

The most common means for input of a URL to a browser include: i) user typing of a URL into a text box control of a browser; and ii) user selecting a hyperlink within a web document object that associates with a URL.

Further, many text based programs (for example word processors, email clients, and chat/instant message clients) include a function which automatically reformats text that is in a URL format to a hyperlink. As such, the formatted text becomes a control which, if selected by the user (for example the user clicking on the text), drives the program generates a process start call to the operating system which spawns a browser and directs such browser to the URL associated with the hyperlink.

Utilizing existing technology is extremely cumbersome for a first user of a browser operating on a first system (e.g. a first browser) to direct, or refer, a second user operating a browser on a second system which is independent from the first system (e.g. a second browser).

For example, the first user could telephone the second user and annunciate the URL and the second user would type the URL into the second browser.

As another example, the first user could cut and past the URL from the first browser to an email client for sending to the second user. Upon receipt, the second user's email client is likely to format the URL as a hyperlink and, if clicked by the second user, initiate a start process call to the operating system to spawn a browser and direct the browser to the URL.

As yet another example, the first user could cut and past the URL from the first browser to a chat or instant message client with an open session with the second user. Upon receipt by the second user's chat or instant message client the URL is likely to be reformatted as a hyperlink and, if clicked by the second user, initiate a start process call to the operating system to spawn a browser and direct the browser to the URL.

As yet another example, the first user may select a “send link” command in the first browser. In response thereto, the first browser may initiate a start process call to the operating system to spawn a new email object and insert the URL into a body portion of the new email object. The first user then may address the email object and activate a send command for purposes of sending the email to the second user. Again, upon receipt the second user's email client is likely to format the URL as a hyperlink and, if clicked by the second user, initiate a start process call to the operating system to spawn a browser and direct the second browser to the URL.

Each of these processes is cumbersome and becomes even more cumbersome if the two users are trying to coordinate their browsing such that they are looking at multiple web pages in a common sequence and communicating about the web pages.

As such, what is needed is an improved system and method to refer web pages and facilitate social browsing amongst at least two individuals, each of which operates a distinct browser. Further yet, what is needed is a system and method for monetizing the referral of web pages. More specifically, what is needed is a system and method that provides a convenient means for referring web pages from a source client system to a target client system and, when the referred page is that of an advertising merchant, and upon the occurrence of a revenue event coinciding with or following the referral of the web page, initiating a charge to the advertising merchant.

### SUMMARY OF THE INVENTION

One aspect of the present invention comprises a system for monetizing the referral of web pages. This aspect of monetization comprises charging an advertising merchant, directly or indirectly through a third party partner, a fee for each of various revenue events that: i) may be associated with the referral of the advertising merchant's web page; or ii) occur following the referral of the advertising merchant's web page.

The system comprises a source client system, at least one target client system, a referral server, and an accounting server. The source client system may be operated by a first user and comprise a source web browser adapted to render the advertising merchant's web page. As will be discussed, the source client system may originally obtain the advertising merchant's web page by: i) selecting the advertising merchant within search results provided by a third party partner system; ii) selecting an advertisement within a web page; or iii) other methods a user utilizes to navigate the world wide web.

The source client system also includes a source referral module coupled to the source web browser. The source referral module is adapted to, in response to user selection of at least one target client; generate a referral message to the referral server. The referral message, at a minimum, identifies at least one target client and the advertising merchant's web page that is rendered by the browser at the time the user elects to initiate the referral.

The referral server may be adapted to, in response to receipt of the referral message from the source client system, provide a referral instruction to at least one target client system. Each target client system is distinct from the source client system and is operated by one of the identified target clients. The referral instruction, at a minimum, includes identification of the advertising merchant's web page.

The target client system comprises a target referral module and a target web browser. The target referral module is adapted to: i) receive the referral message and render a window (i.e. a slider window) prompting the target client to one of accept and decline the referral message; and ii) upon the target client accepting the referral message, pass identification of the advertising merchant's web page to the target web browser. The target web browser then renders the advertising merchant's web page on the target client system by way of spawning a new browser window; spawning a new browser tab; and/or overloading an web page in an existing browser window or tab.

The target referral module may also generate an informational message upon the execution of a revenue event by the target client system. The revenue event may be an event selected from a group of events consisting of: i) rendering the advertising merchant's web page on the target client system; ii) generating a second referral message to the referral server, the second referral message including identification of the advertising merchant's web page and at least a second target client; iii) linking to an additional web page related to the advertising merchant's web site (i.e. drilling down); and iv) posting information entered into data fields by the target client to the advertising merchant (i.e. registration, survey, purchase, etc).

The referral module initiates transfer of the informational message to the accounting server. Such transfer may be directly to the accounting server or indirectly through the referral server or a third party partner's server systems.

If the transfer of the informational message is provided to the accounting server indirectly through the referral server or a third party partner system, it may be aggregated with information from other informational messages and provided by the referral server or third party system to the accounting server as a report (i.e. a combination of multiple informational messages).

The accounting server may be adapted to: i) in response to receipt of the informational message, including receipt of a plurality of informational messages aggregated into a report: i) debit at least a referral fee from an account associated with the advertising merchant's web page; and ii) credit the referral fee to an account associated with the referral server providing the referral instruction.

In more detail, each revenue event may be associated with a particular referral fee and, upon an informational message indicating occurrence of a revenue event associated with, or following, the referral of the advertising merchant's web page: i) debit at least the referral fee associated with the reported revenue event from an account associated with the advertising merchant's web page; and ii) credit at least a portion of such referral fee to an account associated with the referral server providing the referral instruction.

In one particular embodiment wherein the revenue event is generating a second referral message to the referral server, the second referral message includes at least identification of the advertising merchant's web page and identification of at least a second target client (i.e. a subsequent referral), the target referral module is further adapted to operate as a source referral module in that it generates the second referral message to the referral server.

The referral server is adapted to provide a second referral instruction to each second target client system. Each second target client system is distinct from both the source client system and the target client system and is operated by one of the second target clients. The second referral instruction includes, at a minimum, identification of the advertising merchant's web page.

Each second target client system comprises a web browser and a second target client referral module—which operates in the same manner (or may be the same software widget) as the target client referral module discussed above. More specifically, the second target referral module is adapted to: i) receive the second referral message and render a window prompting the second target client to one of accept and decline the referral message; and ii) upon the second target client accepting the referral message, pass identification of the advertising merchant's web page to the web browser. The second target web browser renders the advertising merchant's web page on the second target client system.

The second target client referral module also may: i) generate a second informational message upon the execution of a revenue event (as described above) by the second target client system; and ii) initiate transfer of the informational message (directly or indirectly) to the accounting server. Again, the accounting server may be adapted to: i) in response to receipt of the informational message: i) debit a referral fee from an account associated with the advertising merchant's web page; and ii) credit the referral fee to an account associated with the referral server providing the referral instruction.

In one aspect of the present invention, the source client system may originally obtain the advertising merchant's web page by way of clicking on in impression of the advertising merchants paid listing within search results or an impression of the advertising merchant's advertisement content rendered within some other web page within which the merchant is advertising (such other web page or the search results page may be generically referred to as a base web page for purposes of describing the present invention).

In this aspect, the system again comprises a source client system operated by a first user, at least one target client system operated by a second user, a referral server, and an accounting server.

The source client system comprises a source web browser adapted to render the base web page (i.e. the search results page inclusive of the paid listing therein and/or a page inclusive of the advertising merchant's advertisement content therein). In each case, the paid listing or the advertisement content is associated with the advertising merchant's web page (i.e landing page).

In response to the user selecting (i.e. clicking) on the paid listing or the advertisement content, the web browser is adapted to generate a link to the advertising merchant's web page. Such linking may be by way of initially linking to a redirect URL associated with the paid listing or the advertisement content and, in response to linking to the redirect URL, being provided with the URL of a landing page of the merchant's web page.

The source client system further comprises a referral module coupled to the web browser. The referral module is adapted to, in response to user selection of at least one target client, generate a referral message to a referral server. The referral message, at a minimum, identifies at least one target client and the advertising merchant's web page.

The referral server may be adapted to, in response to receipt of the referral message from the source client system, provide a referral instruction to a target client system. Each target client system is distinct from the source client system and is operated by one of the identified target clients. The referral instruction, at a minimum, includes identification of the advertising merchant's web page.

The accounting server may be adapted to, in response to receipt of an informational message indicating that the target client system as executed a revenue event (or receipt of a combination of multiple such informational messages within a report): i) debit at least a referral fee from an account associated with the advertisement impression or paid listing; and ii) credit the referral fee to an account associated with the referral server providing the referral instruction.

Again, the revenue event may be an event selected from a group of events consisting of the target client system: i) rendering the advertising merchant's web page on the target client system; ii) generating a second referral message to the referral server, the second referral message including identification of the advertising merchant's web page and at least a second target client; iii) linking to an additional web page related to the advertising merchant's web site (i.e. drilling down); and iv) posting information entered into data fields by the target client to the advertising merchant (i.e. registration, survey, purchase, etc).

The informational message may be initiated by the target client system. More specifically, a referral module operating on the target client system may be adapted to: i) receive the referral message and render a window prompting the target client to one of accept and decline the referral message; and ii) upon the target client accepting the referral message, pass identification of the advertising merchant's web page to a target client system web browser.

Again, the target web browser renders the advertising merchant's web page on the target client system by way of spawning a new browser window; spawning a new browser tab; and/or overloading an web page in an existing browser window or tab.

Upon execution of the revenue event, the referral module may generate the informational message and initiate transfer the informational message, directly or indirectly, to the accounting server.

In this aspect, in additional to debiting and crediting the referral fee, the accounting server may further, upon the source client originally selecting (i.e. clicking) the paid listing or advertising content within the base page—and the source web browser generating a click report to the accounting server: i) debit a click fee from an account associated with the advertising merchant; and ii) credit the click fee an account associated with the base web page. The click fee is distinct from the referral fee.

In one aspect of the present invention, a third party partner system operating a search service or advertisement server (generically referred to as an advertisement server or search system) may maintain a contractual relationship with the advertising merchant. The search/advertisement server may be adapted to: i) maintain an index of at least two distinct advertisement classifications; ii) associate with each advertisement classification, at least one relevant advertisement (inclusive of a relevant paid search listing).

In response to receipt of a search request or advertisement request including a search query, the advertisement server may: i) determine the advertisement classification to which the search query matches; and ii) return a relevant advertisement from the classification to which the search query matches. The advertisement may be structured as a paid search listing returned within search results.

Upon receipt of a click report from a system on which the advertisement is rendered (which may include the system linking to a redirect URL associated with the advertisement), an accounting server associated with the advertisement server may: i) debit a first advertisement fee (i.e. a click fee) from an account associated with the relevant advertisement; and ii) credit the first advertisement fee to an account associated with the advertisement server.

A source client system, operated by a first user, may include a web browser and a referral module coupled to the web browser. The web browser may be adapted to: i) obtain user entry of the search query; ii) generate the search request to the advertisement server; and iii) in response to receipt of search results, rendering the advertisement or paid listing in combination with the search results.

In response to user selection of the advertisement or paid listing, the source web browser may: i) generate the click report to the advertisement server; and ii) link to a URL associated with the paid search result or advertisement content to obtain the advertising merchant's landing page.

The referral module may be adapted to, in response to user selection of at least one target client, generate a referral message to a referral server. The referral message identifies, at a minimum, at least one target client and the advertising merchant's page.

The referral server may be adapted to provide a referral instruction to at least one target client system. Each target client system is distinct from the source client system and is operated by one of the identified target clients. The referral instruction comprises, at a minimum, identification of the referred web page.

The advertisement server may be further adapted to receive an informational message. The informational message may include an indication that the target client system has executed a revenue event.

The revenue event may be any event selected from a group of events consisting of the target client system: i) rendering the advertising merchant's web page on the target client system; ii) generating a second referral message to the referral server, the second referral message including identification of the advertising merchant's web page and at least a second target client; iii) linking to an additional web page related to the advertising merchant's web site (i.e. drilling down); and iv) posting information entered into data fields by the target client to the advertising merchant (i.e. registration, survey, purchase, etc).

In response to receipt of the informational message, the accounting server associated with the advertisement server: i) debits at least a referral fee from the account associated with the relevant advertisement; and ii) credits the referral fee to an account associated with the referral server providing the referral instruction. The debit may be for more than the referral fee paid to the account associated with the referral server to reflect a revenue split arrangement between the operator of the referral server and the operator of the advertisement or search server.

In one particular embodiment, the target client system includes a referral module adapted to: i) receive the referral message and render a window prompting the target client to one of accept and decline the referral message; and ii) upon the target client accepting the referral message, pass identification of the advertising merchant's landing page to a target client system web browser.

The referral module may also, upon the execution of the reportable event: i) generate an informational message, and ii) transfer the informational message to the referral server. The informational message includes identification of the advertising merchant's website and identification of the reportable event.

In this embodiment, the referral server further comprises: i) a database comprising a plurality of reportable event data sets, each reportable event dataset associating the indication of the advertising merchant's website and the identification of the reportable event; and ii) a reporting tool.

The reporting tool is adapted to, upon receipt of a report request, generate the informational message (or a report comprising a plurality of informational messages) to the accounting server associated with the advertisement server. The informational message includes at least one reportable event dataset.

For a better understanding of the present invention, together with other and further aspects thereof, reference is made to the following description, taken in conjunction with the accompanying drawings. The scope of the present invention is set forth in the appended claims.

### BRIEF DESCRIPTION OF THE DRAWINGS

FIG. 1 is a block diagram representing an exemplary system for implementing referral and monetization of web pages in accordance with an embodiment of the present invention;

FIG. 2 is a ladder diagram representing an exemplary operation of system for implementing referral and monetization of web pages in accordance with an embodiment of the present invention;

FIG. 3 is a diagram depicting an exemplary search request in accordance with an embodiment of the present invention;

FIG. 4 is a diagram depicting an exemplary paid listing in accordance with an embodiment of the present invention;

FIG. 5 is a diagram depicting an exemplary redirect URL in accordance with an embodiment of the present invention;

FIG. 6 is a diagram depicting an exemplary referral message in accordance with an embodiment of the present invention;

FIG. 7 is a diagram depicting an exemplary referral instruction in accordance with an embodiment of the present invention;

FIG. 8 is a diagram depicting an exemplary informational message in accordance with an embodiment of the present invention;

FIG. 9 is a table diagram representing exemplary data relationships of an impression data storage in accordance with an embodiment of the present invention;

FIG. 10 is a table diagram representing exemplary data relationships of a revenue events table in accordance with an embodiment of the present invention;

FIG. 11 is a table diagram representing exemplary data relationships of a reportable events table in accordance with an embodiment of the present invention;

FIG. 12 is a flow chart representing exemplary monitoring of browser activity for reportable events in accordance with an embodiment of the present invention;

FIG. 13 is a block diagram representing an exemplary accounting server in accordance with an embodiment of the present invention;

FIG. 15 is a flow chart representing an exemplary operation of an accounting server in accordance with an embodiment of the present invention;

FIG. 16 is a block diagram representing an exemplary system for implementing referral of web pages in accordance with an embodiment of the present invention;

FIG. 17a is a ladder diagram representing an exemplary process for redirecting a remote browser to selected web content in accordance with an embodiment of the present invention;

FIG. 17b is a ladder diagram representing an exemplary process for establishing a chat session between two client systems in accordance with an embodiment of the present invention;

FIG. 18 is a diagram representing exemplary operation of certain processes related to user authentication and provisions of a user's buddy list;

FIG. 19 is a diagram depicting an exemplary user interface useful for facilitating social browsing in accordance with an embodiment of the present invention;

FIG. 20 is a diagram depicting an exemplary user interface useful for facilitating social browsing in accordance with an embodiment of the present invention;

FIG. 21 is a diagram depicting an exemplary user interface useful for facilitating social browsing in accordance with an embodiment of the present invention;

FIG. 22 is a diagram depicting an exemplary user interface useful for facilitating social browsing in accordance with an embodiment of the present invention;

FIG. 23 is a block diagram depicting exemplary structure of a client system in accordance with an exemplary embodiment of the present invention;

FIG. 24 is a block diagram depicting exemplary processes included in a plug-in component of a client system in accordance with an exemplary embodiment of the present invention;

FIG. 25a is a block diagram depicting exemplary processes included in a listener component of a client system in accordance with an exemplary embodiment of the present invention;

FIG. 25b is a block diagram depicting exemplary processes included in a listener component of a client system in accordance with an exemplary embodiment of the present invention;

FIG. 26 depicts an exemplary connections table in accordance with an exemplary embodiment of the present invention; and

FIG. 27 depicts exemplary steps for selecting an advertisement placement for rendering in conjunction with an instance of the web browser in accordance with an exemplary embodiment of the present invention.

### DETAILED DESCRIPTION OF THE EXEMPLARY EMBODIMENTS

The present invention will now be described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should also be appreciated that many of the elements discussed in this specification may be implemented in a hardware circuit(s), a processor executing software code, or a combination of a hardware circuit(s) and a processor or control block of an integrated circuit executing machine readable code. As such, the term circuit, module, server, or other equivalent description of an element as used throughout this specification is intended to encompass a hardware circuit (whether discrete elements or an integrated circuit block), a processor or control block executing code, or a combination of a hardware circuit(s) and a processor and/or control block executing code.

It should also be appreciated that table structures represented in this application are exemplary only and intended to show the mapping of relationships between various data elements. Other data structures may store similar data elements in a manner that maintains the relationships useful for the practice of the present invention.

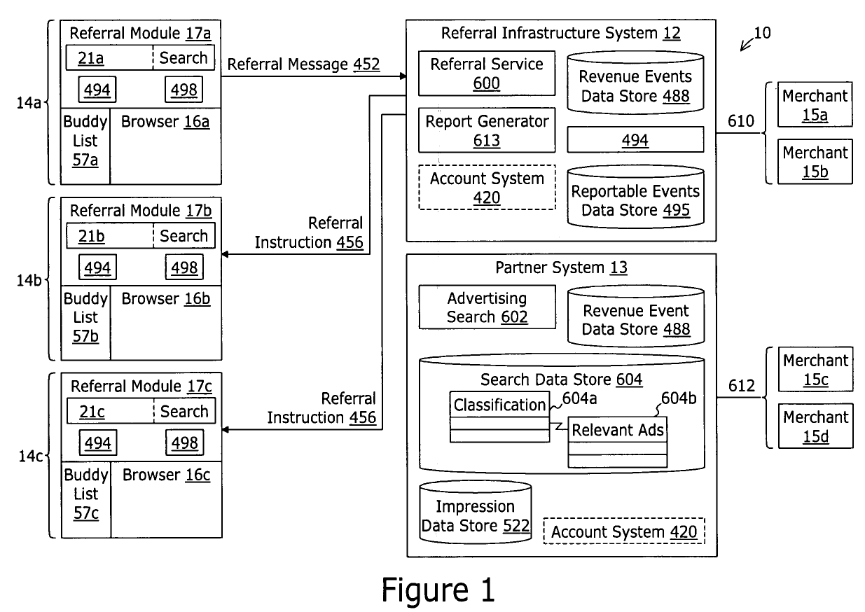

FIG. 1 represents an overview of exemplary architecture for implementing a network based system and method for referring web pages and monetizing the referral of web pages in accordance with an embodiment of the present invention (the referral system 10).

For purposes of referring web pages from a source client system (for example client system 14a) to each of a plurality of target client systems (for example client systems 14b and 14c), the system includes a referral infrastructure system 12 (inclusive of a referral service system 600) and a local referral module 17a, 17b, 17c for installation on, and operation with a web browser 16a, 16b, 16c installed on, each of a plurality of client systems 14a, 14b, 14c respectively.

In general, each referral module 17a is communicatively coupled to the referral service system 600 for purposes of initiating referral messages 452 to the referral service system 600 and receiving referral instructions 456 from the referral service systems 600.

In more detail, each referral module (using referral module 17a of the source client system 14a as an example) includes a buddy list control 57a for obtaining user selection of an invitee (also referred to as a target client in this specification) to which the user desires to refer a web page. In response to obtaining such user selection of at least one invitee to which a web page is to be referred, the referral module 17a initiates a referral message 452 to the referral service system 600. As will be discussed, the referral message 452 includes at least identification of the invitee and identification of the referred web page—which may be the URL of the web page rendered by the browser 16a at the time of such user selection.

In response to receipt of the referral message 452, the referral service system 600 performs various processes that include at least generating a referral instruction 456 to one or more target client systems (for example client systems 14b, 14c). Each target client system 14b, 14c is distinct from the source client system 14a and is operated by one of the invitees identified in the referral message 452. The referral instruction 456 includes at least identification of the referred web page.

In response to receipt of a referral instruction 456, the referral module 17b, 17c may generate an invite message such as a slider window or other notice prompting the user to accept the referral of the web page. Following user acceptance of the referral, or in response to receipt of the referral instruction 456 if user acceptance of the referral is not required, the referral module 17b, 17c passes the identification of the referred web page to the web browser 16b, 16c such that the web browser 16b, 16c loads and renders the referred web page by spawning of a new browser window, spawning a new browser tab, or overloading an existing web page.

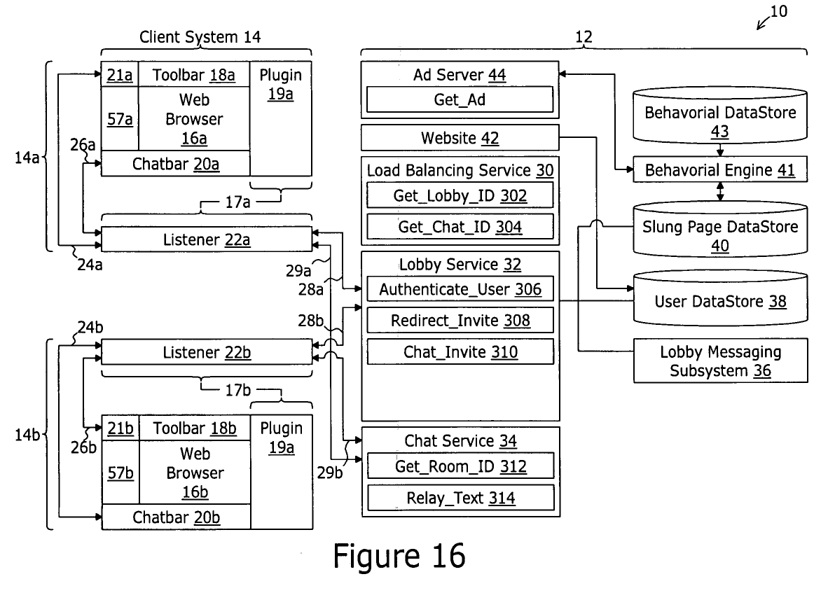

It should be appreciated that the foregoing discussion provides a description of an exemplary system for referring web pages. A detailed discussion of one example of a system and method that may be used for implementing the referral of web pages is included with respect to FIG. 16 through FIG. 27 and the corresponding portions of this specification.

For purposes of monetizing the referral of web pages in one aspect, it is envisioned that advertising merchants 15a, 15b, 15c, 15d are willing to provide compensation (directly or indirectly) to the operator of the referral infrastructure system 12 in the event the referral infrastructure system 12 facilitates various events which may be likely to be useful to the sales and marketing efforts of the advertising merchant. For purposes of illustration, those events for which the advertising merchant may be willing to provide compensation may be events the target client may initiate following the target client system obtaining the advertising merchant's web page by way of receiving a referral instruction 456. Such events may be referred to as revenue events.

Turning briefly to FIG. 10, exemplary revenue events 490 include: i) the target client accepting the advertising merchant's web page as a referred web page and rendering the web page on the target client system 14b; ii) the target client subsequently referring the advertising merchant's web page to one or more other target clients (i.e. the target client system 14b, after receiving and rendering the referred web page, operating as the source client system 14a and referring the web page to other target client systems); iii) the target client “drilling down” into the advertising merchant's web site—such as by activating links to obtain other pages of the advertising merchant's web site; iii) posting information to the advertising merchant's web site such as entering data into fields within the web page for post to the advertising merchant's web server; and iv) purchasing a product or service from the advertising merchant. Examples of posting information may include: i) registering on the advertising merchant's web site; ii) completing a survey; iii) providing demographic information to the advertising merchant; or iv) participating in (or providing information related to) any multitude of marketing programs an advertising merchant may choose to implement.

Returning to FIG. 1, it is envisioned that a portion of the advertising merchants (for example merchants 15a and 15b) may have a contractual relationship with the operator of the referral infrastructure system 12 and may provide the applicable compensation for the occurrence of each revenue event directly to the operator of the of the referral infrastructure system 12. It is also envisioned that a second portion of the advertising merchants (for example merchants 15c and 15d) may have a contractual relationship with an operator of a partner system 13 such as a web search service or internet advertising placement service that may provide paid listings within its search results, advertisements space within search results, or other forms of distributing a merchant's advertising content for purposes of promoting the merchant and/or the merchant's website. As such, an advertising merchant within the second portion of merchants may compensate the operator of the referral infrastructure system 12 indirectly by compensating the operator of the partner system 13 for the occurrence of each revenue event—with the operator of the partner system 13 in turn compensating the operator of the referral infrastructure system 12.

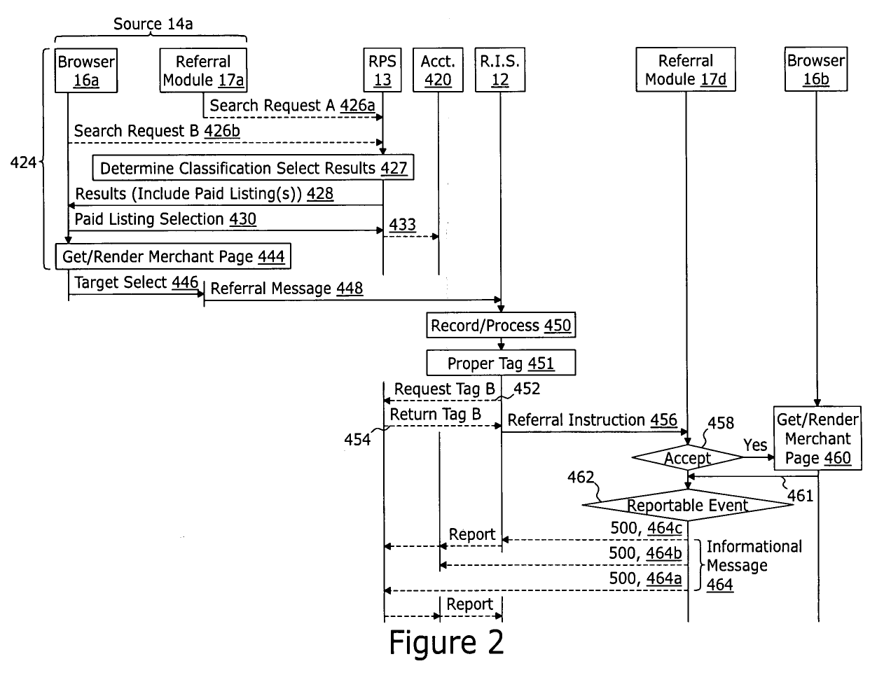

FIG. 2 is a ladder diagram depicting exemplary components and their interaction for the above described aspect of monetizing the referral of web pages by way of tracking the occurrence of certain revenue events associated with the referral of a web page (or multiple web pages) from a source client system 14a to at least one target client system 14b—and accounting for each revenue event with applicable debits to an advertising merchant's account and credits to an account associated with the system providing the web page referral (i.e. the referral system 12).

The exemplary components and their interaction, as described, provide for such monetization both: i) in an environment where there is a direct contractual relationship between an advertising merchant and the operator of the referral system 12 such that fund transfer in accordance with the accounting for each revenue event is directly between the advertising merchant and the operator of the referral system 12; and ii) in an environment where a partner (operating a partner system 13 such as a search engine) is an intermediary—meaning the partner has a both a contractual relationship with the advertising merchant and a related contractual relationship with the operator of the referral system 12 such that fund transfer in accordance with the accounting for each revenue event is a charge to the advertising merchant by the partner and a separate charge (typically a lesser charge) by the operator of the referral system 12 to the partner.

Referring to FIG. 2 in conjunction with FIG. 1, the group of steps 424 represent the user of the browser 16a of the source client system 14a acquiring and rendering a web page in a typically manner. Such steps 424 may include the user entering a search query into the search box 21 of the referral module 17a and transfer of the entered search query to a search service system 602 of the remote partner system 13 as a search request 426a.

Alternatively, the user may enter a search query into a search box of a web page (not shown) rendered within the browser 16a and transfer of the entered search query to the remote partner system 13 as a search request 426b. The web page may be a web page provided by a web server of the remote partner system 13, the referral system (i.e. the referral system home page), or yet another system.

For purposes of describing exemplary aspects of the present invention, a search request for a query entered into the search box 21 of the referral module 17 may be referred to as a “search request A” and a search request for a query entered into a search box of a web page rendered within the browser 16 may be referred to as a “search request B”.

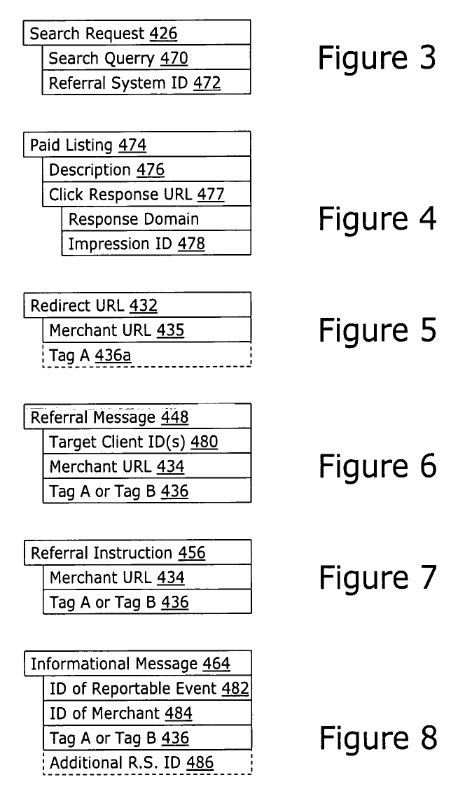

Turning briefly to FIG. 3, the search request 426 (whether A or B) may include the search query 470 entered by the user and a referral system ID 472 (i.e. a partner ID typically assigned by the remote partner system 13). In the example of search request A, the referral system ID 472 will be an identifier associated the referral system 12. In the example of search request B, the referral system ID 472 may be: i) an identifier associated with the referral system 12 if the web page is a web page controlled by the operator of the referral system 12 (i.e. home page); ii) an identifier associated with the third party provider of the web page into which the search query is entered (if any); and iii) an identifier associated with the remote partner system 13 (or no identifier at all) in the absence of any other applicable identifier.

Returning to FIG. 2 in conjunction with FIG. 1, in response to either search request A or search request B, the search service system 102 of the remote partner system 13 may query a search database 604 in a traditional manner to return search results 428 for rendering in the browser 16a. More specifically, the search database 604 may comprise an index 604a of multiple advertisement classifications (at least two classifications). Associated with each classification is at least one relevant advertisement and/or paid search listing 604b of an advertising merchant that is willing to pay fees for certain advertising events. A common advertising event for which a merchant pays a fee is the user selecting the paid listing from the search results (i.e. a click) and, as a result of such selection, being linked to a landing page of the advertising merchant's web site.

Step 427 represents determining the relevant classification 604a to which the search query matches and selecting at least one relevant advertisement and/or paid listing from such matching classifications. As such, the search results 428 may include the advertisement and or at least one paid listing.

Referring to FIG. 4 in conjunction with FIG. 2, each paid listing 474 may include: i) a description 476 corresponding to the search query 470 (FIG. 3) or other creative content designed to entice the user to select the paid listing 474; and ii) a click response URL 477 which may be a URL within the domain of the remote partner system 13 with an extension that includes a unique impression ID 478 assigned by the search service 602 and useful for associating the particular impression of the paid listing 474 with the advertising merchant and the referral system (i.e. the search system's revenue share partner) from which the search request 426 originated.

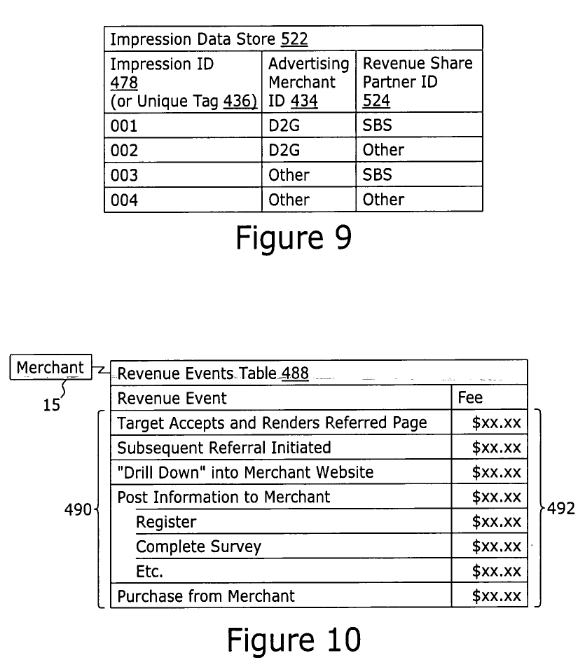

More specifically, referring to FIG. 9 in conjunction with FIG. 1, the search service 602 may maintain an impression data store 522. The impression data store 522 associates, for each paid listing 474 (FIG. 4) provided within search results 428 (FIG. 2), the unique impression ID 478 associated with the paid listing, identification of the advertising merchant 434 (which may be the URL of the advertising merchant's landing page); and identification of the referral system (i.e. revenue share partner ID 524), if any.

Returning to FIG. 2, step 430 represents the user clicking on a paid listing 474 resulting in the browser 16a establishing a connection to the click response URL thereby passing the unique impression ID 478 to the remote partner system 13.

In response, the remote partner system 13 identifies the advertising merchant (for example, by looking up the advertising merchant ID associated with the unique impression ID 478 in the impression data store 522) and returns a redirect URL 432 to the browser 16a.

Referring to FIG. 5 in conjunction with FIG. 2, the redirect URL 432 includes the URL of the landing page of the advertising merchant's web site (i.e. the advertising merchant URL 435) and may include an extension that includes a unique tag (referred to in this application as unique tag A) 436a. The unique tag 436a, if included, may be a tag assigned by the remote partner system 13—and in some circumstances may be the unique impression ID 478.

The remote partner system 13 may maintain the association of the unique tag 436a with both the advertising merchant ID 434 and the revenue share partner ID 524 from which the search request 426 originated by way of a record in the impression data store 522.

Additionally, the remote partner system 13 may generate a message 433 to the accounting system 420 to charge the advertising merchant 15 for the redirect if the contractual relationship between the advertising merchant and the operator of the partner system 13 is such that a charge is due upon the partner system 13 linking a user to the advertising merchant's web page (i.e. a click fee).

After establishing a connection to the redirect URL 432, the browser 16a renders the advertising merchant's landing page on the source system 14a as depicted by step 444.

At some point while the user of the source system 14a is browsing the advertising merchant's web site, the user may utilize the buddy list control 58 of the referral module 17a to refer one of the advertising merchant's web pages to at least one target client. The user initiating the referral is represented by step 446.

Further upon receipt of the referral message 448, an optional process of obtaining a unique tag (referred to as unique tag B) 436b from the remote partner system 13 may be performed in the event the tag A 436a is not associated with the remote referral system 12. The optional process may include a request 452 for the tag B and a response 454 including the tag B. Exemplary methods for implementing the request and response may be by way of a connection to a predefined URL for making the request or via web services messaging.

The referral system 12 may obtain this tag B in circumstances where: i) it is known or is likely that the advertising merchant 15 has a contractual relationship with the operator of the remote partner system 13 wherein the advertising merchant is willing to pay for having the target client(s) linked to the advertising merchant's web site (or having the target client perform some other action resulting in a revenue event after being linked to the advertising merchant's web site; and ii) the tag A is not present or, if present, does not identify the referral system 12 as the source of the referral (i.e. tag A 436a does not associate with the referral system 12 in the impression data store 522 maintained by the search system 13).

If a tag A is present and identifies the referral system 12 as the source of the referral, there is no need to obtain the tag B. The purpose of tag B is to identify referral system 12 as the revenue share partner of the remote partner system 13 for any revenues earned by the remote partner system 13 from the advertising merchant which are the result of revenue events facilitated by the referral of the web page to the target client(s). As such, if tag A already identifies the referral system 12 as the revenue share partner, there is no need to obtain the tag B.

The referral system 12 further generates the referral instruction 456 to each target client system 14b, 14c. Referring to FIG. 7 in conjunction with FIG. 2, the referral instruction 456 includes at least: i) the advertising merchant URL 434; and iii) the tag 436 (either tag A or tag B). Again, as discussed, the tag 436 may be appended to the advertising merchant URL 434 as an extension.

Step 458 represents the target client accepting the referral and step 460 represents rendering of the referred merchant's web page by the browser 16b of the target client system 14b.

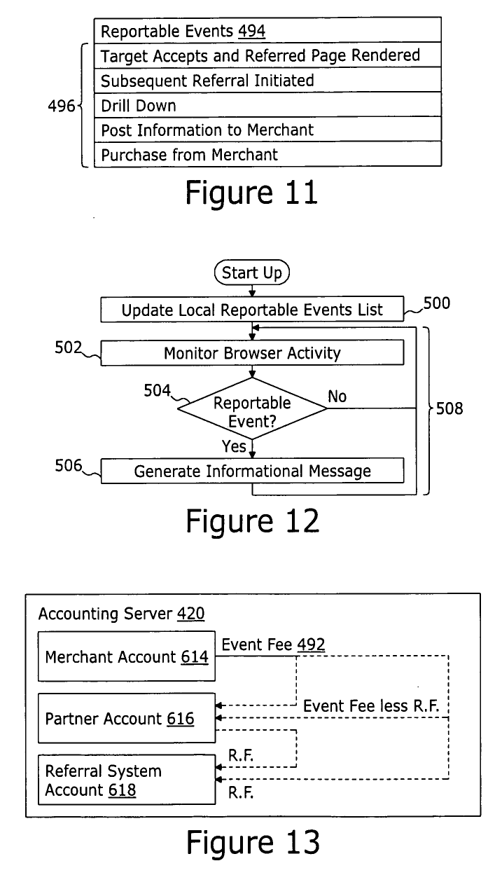

After the referred merchant's web page is rendered within the browser 16b, the target client may perform a plurality of different actions 461, at least some of which may be revenue events 490 (FIG. 10) or reportable events 496 (FIG. 11). In response to one or more actions 461 which are reportable events, determined at step 462, an informational message generator 498 of the referral module 17b generates an informational message 464.

Turning briefly to FIG. 11, a reportable events list 494 comprises a list of reportable events 496 which comprises a superset of at least all revenue events 490 (FIG. 10) applicable to any merchant 15. Or stated another way, any event which is (or could be expected to be) a revenue event 490 for any merchant 15 is a reportable event 496 and included within the list of reportable events 496.

As depicted in FIG. 1, the reportable events list 494 may be implemented in the referral system 12 as well as within each referral module 17. FIG. 12 depicts exemplary steps implemented within an informational message generator 498. Referring to FIG. 12 in conjunction with FIG. 1 and FIG. 11, in operation, upon start up, the informational message generator 498 may make an applicable connection to the referral system 12 for purposes of updating the reportable events lists 494 to reflect any additions or deletions from the list of reportable events 496 that trigger generation of an informational message 464.

Following start up, the informational message generator 498 monitors activity of the local web browser 16 at represented by step 502. Upon detecting a reportable event 496, an informational message 464 is generated as represented by step 506. The feedback loops 508 represent continual monitoring of the browser and comparison of browser events to the list of reportable events and, upon each occurrence of a reportable event (or following the occurrence of multiple reportable events), generating an informational message.

Determining whether an action 461 is a reportable event 496 (i.e. an action that is, or could be, a revenue event) may comprise looking up whether the action 461 corresponds to a defined reportable event within the reportable event list 494.

In various exemplary embodiments, the informational message 464 (or a report 500 (FIG. 28) comprising a one or more informational messages 464 in combination) may be sent to: i) the remote partner system 13 directly for accounting by the remote partner system as represented by 464a; ii) the referral system 12 as represented by 464c for subsequent reporting to an accounting system which may, or may not be part of the remote partner system, iii) an accounting server 420 directly (which may be part of either the remote partner system 13 and/or the referral system 12) as represented by 464b; and/or iv) any combination or permutations of the above. Further, in the event that the report 500 or informational message 464 is first provided to the referral system 12, the informational message 464 or at least a portion of the report 500 may be further transferred to the accounting server 420 and/or the remote partner system 13. Similarly, in the event the report 500 or informational message 464 is first provided to the remote partner system 13, the informational message 464 or at least a portion of the report 500 (which may include additional information such as credits of referral fees) may be transferred to the referral system. More broadly, in any situation wherein the remote partner system 13 maintains the contractual relationship with the advertising merchant, a report 500 may be transferred to the referral system 12 describing referral fees payable for those reportable events which are revenue events. Such reporting is represented by the arrow(s) labeled reports.

Referring to FIG. 8 in conjunction with FIG. 2, the informational message 464 may include: i) a reportable event identifier 482 identifying the reportable event (i.e. the potential revenue event); ii) an advertising merchant identifier 484 identifying the advertising merchant or the advertising merchant's web site on which the revenue event occurred; iii) the tag 436 (whether the tag A or the tag B); and iv) optionally (if there is no tag A or tag B identifying the referral system 12 as the revenue sharing partner facilitating the occurrence of the revenue event) an additional revenue sharing ID 486 identifying the operator of the referral system 12.

Referring to FIG. 28 in conjunction with FIG. 2, an exemplary report 500 may include a plurality of records 502, each associated with an advertising merchant identified by an advertising merchant identifier 484 such as the merchant's URL. In more detail, at least two records exist and each represents a distinct advertising merchant. Associated with the advertising merchant 484 are fields representing each reportable event 496a-496d, each identifying the reportable event. Within each field may be the quantity of occurrences of such reportable event for such merchant within the period of time covered by the report.

Returning again to FIG. 10, the revenue events table 488 depicted in FIG. 10 depicts an organizational structure for recording, for an advertising merchant, fees 492 associated with each of a plurality of defined revenue events 490. As discussed, revenue events comprise events for which the advertising merchant is willing to pay the fee in consideration of the remote partner system 13 and/or the referral system 12 facilitating the occurrence of such revenue event.

As such, and as depicted in FIG. 1, the revenue events table 488 may be implemented in the remote partner system 13 for support of facilitating revenue events for merchants 15c, 15d that maintain a contractual arrangement 612 with the remote partner for payment of the fee to the remote partner in response to the occurrence of each revenue event. The revenue events table 488 may be implemented in the referral system 12 for support of facilitating revenue events for merchants 15a, 15b that maintain a direct contractual relationship 610 with the operator of the referral system for payment of the fee to the operator in response to the occurrence of each revenue event.

As discussed, exemplary revenue events 490 include: i) the target client accepting the referred merchant's web page and rendering of such referred merchant's web page on the target client system 14b (i.e. the occurrence of steps 458 and 460 as described with respect to FIG. 2); ii) the target client subsequently referring the advertising merchant's web page to one or more other target clients (i.e. the target client system 14b, after receiving and rendering the referred web page, operating as the source client system 14a and referring the web page to other target client systems as discussed with respect to FIG. 2); iii) the target client “drilling down” into the advertising merchant's web site—such as by activating links to establish connections to other pages of the advertising merchant's web site or post extension tags to the web site to link to other pages in the advertising merchant's web site; iii) posting information to the advertising merchant's web site such as entering data into fields within the web page for post to the advertising merchant's web server; and iv) purchasing a product or service from the advertising merchant. Examples of posting information may include: i) registering on the advertising merchant's web site; ii) completing a survey; iii) providing demographic information to the advertising merchant; or iv) participating in (or providing information related to) a marketing programs.

Referring to FIG. 13 in conjunction with FIG. 10, upon receipt of an informational message 464 including a reportable event ID 482 (FIG. 8) which corresponds to a revenue event 490 applied to the identified merchant, the accounting server 420 debits at least the appropriate event fee 492 from an account associated with the advertising merchant 614 and applies corresponding credit(s) to at least one of a referral account 618 associated with the referral system 12 and a search partner account 616 associated with the partner system 13.

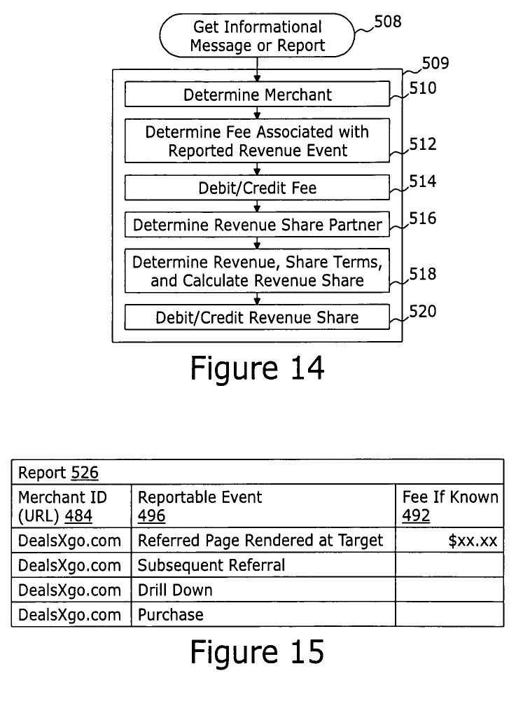

FIG. 14 depicts exemplary steps performed by the accounting server 420 for supporting an exemplary embodiment of the present invention. Referring to FIG. 14 in conjunct with FIG. 13, step 508 represents receiving an informational message 464 (FIG. 8) identifying at least one reportable event 496 (FIG. 11) or a report 526 (FIG. 15) identifying a plurality of reportable events 496—inclusive of at least two reportable events 496, each occurring on distinct client systems 14 (i.e. a first reportable event occurring on a first system and a second reportable event occurring on a second client system).

For each reportable event 496 identified in the informational message 465 or the report 526, step 509 is performed for purposes of implementing the applicable debit and credit(s). Step 509 comprises a plurality of sub steps. At sub step 510, the accounting system 420 determines the advertising merchant to which the reportable event is applicable—which may comprise extracting the advertising merchant ID 484 (which may be a URL of the advertising merchant's web site) from the informational message 464 or the report 526.

Sub step 512 represents determining the fee 492, if any, associated with the reportable event 496. More particularly, sub step 512 represents determining, for the applicable merchant, whether the reportable event 496 is a revenue event 490 with an associated fee 492 as identified in the revenue events table 488.

Sub step 514 represent debiting at least the event fee 492, if any, from an account 614 associated with the advertising merchant and crediting the event fee to an account associated with the remote partner system 13.

Sub step 516 represents determining the revenue share partner facilitating the occurrence of the revenue event—which may be determined from: i) the revenue share ID 486 if included in the informational message, ii) the revenue share partner associated with the tag A or tag B 436 if included in the informational message; iii) or the revenue share partner generating the report.

Sub step 518 represents determining the revenue share terms with the revenue share partner. The revenue share terms may identify a percentage of the fee (determined at step 512) to be paid to the revenue share partner as a referral fee, may identify a flat fee to be paid to the revenue share partner as a referral fee upon occurrence of the reported revenue event; or other terms for establishing a referral fee to be paid to the revenue share partner.

Sub step 520 represents debiting the referral fee from an account associated with the remote partner system 13 and crediting the referral fee to an account associated with the remote partner system 13. It should be appreciated that the referral fee will typically be less than the event fee, as such debiting the event fee includes debiting at least the referral fee—as part of the debited event fee.

Further, although FIG. 14 discusses a credit of the event fee to the account associated with the remote partner system 13 and a subsequent debit of the referral fee for credit to the referral system accent, such discussion is intended to encompass the equivalent model wherein the credit to the account associated with the remote partner system 13 is only the event fee less the referral fee and the referral fee is credited directly to the referral system account without in intermediate credit/debit to the account associated with the remote partner system 13.

Further, although FIG. 14 depicts an exemplary process implemented in the remote partner system 13, such steps may also be used to implement an accounting server 420 in the referral system 12—with the exception that there will likely be no revenue share (i.e. no need to implement sub steps 516 through 520) and the entire event fee 492 would be credited to the referral system account 618.

### Exemplary Referral System

FIG. 16 represents an overview of exemplary system and method for implementing the referral of web pages as discussed with respect to FIG. 1 and FIG. 2.

Each local referral module 17a, 17b may be coupled to a web browser 16a, 16b and may comprise both a browser plug-in component 19a, 19b as well as a listener 22a, 22b. In the exemplary embodiment, the listener 22a, 22b may be a widget application which is loaded into memory for execution at start up of the client system 14a, 14b. The browser plug-in 19a, 19b may be a data link library file which drives operation of each instance of the web browser 16a, 16b (i.e. each new browser window, inclusive of new browser tabs) in accordance therewith.

The browser plug-in (for example browser plug-in 19a) may comprise a toolbar graphical user interface 18a (referred to as the tool bar) and a chatbar graphical user interface 20a (referred to as the chatbar). Each tool bar (using 18a as an example) may include the search interface 21a. The search interface 21 may be a graphical user interface adapted to enable a user to enter a search query, post the search query to the search service 602 of the remote partner system 13, and effect rendering of search results by the web browser 16a.

As discussed, the search results may include paid listings which are search result listing for which an advertising merchant is willing to pay a fee for certain revenue events such as the user clicking on the paid listing for link through to a landing page of the advertising merchant's website.

Although the toolbar 18 and the chatbar 20 are represented as, and may be implemented as, a single browser plug-in component 19 it should be appreciated that the tool bar 18 and the chatbar 20 may be implemented as separate browser plug-ins.

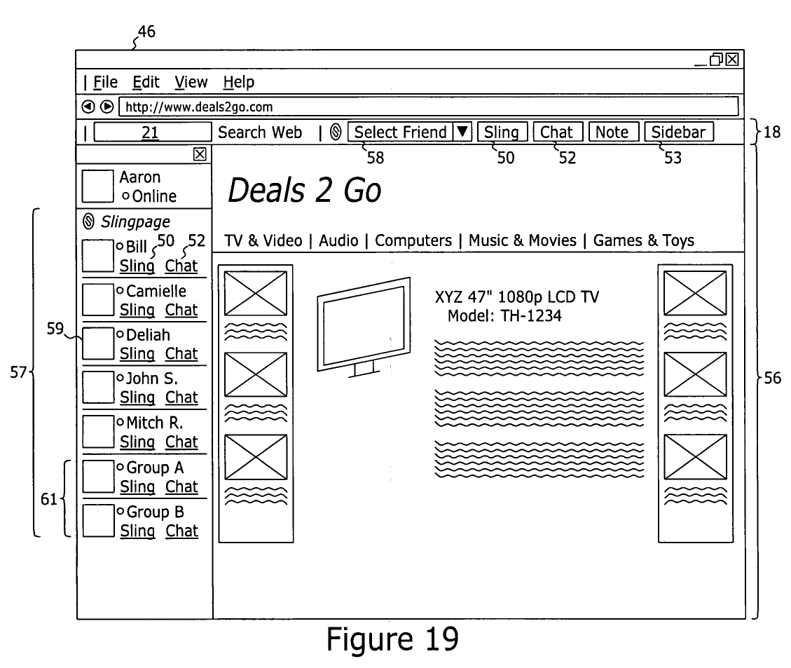

Turning briefly to FIG. 19 in conjunction with FIG. 16, the toolbar 18 may be rendered within, or associated with, a browser window 46 of each instance of the web browser 16 operating on the client system 14. In an exemplary embodiment, the toolbar 18 may comprise one or more controls for initiating referral of a web page (i.e. URL of the web page currently rendered in the browser window 46) to one or more target clients.

In one exemplary implementation, a control for initiating referral of a web page may include a buddy list control rendered as a sidebar 56 in response to the user activation of either a sidebar control 53 from the tool bar 18. The term side bar may mean a frame of the browser window or a frame or window otherwise associated with the browser—such as the window 56 depicted along the left side of the browser window in FIG. 19.

Other exemplary implementations may include rendering of a buddy list in a drop down menu 58, the buddy list control 58 (whether rendered as a side bar 56 or a drop down menu 58) lists user ID's of potential target clients 59 (or groups of target clients 61) to which the user may desire to refer a web page, chat, or otherwise participate in a social browsing session. The buddy list control 58 may further identify, for each potential target client user, whether the user is currently logged into the system (connected to the referral infrastructure system 12 of FIG. 16) by way of distinct text, font, icon color, etc.

The buddy list control 56, 58 may be controllable by a mouse or pointer to solicit and obtain user selection of a selected target client 59 or group of target clients 61. For purposes of the description, each reference to a target client is intended to also encompass a group of at least two target clients.

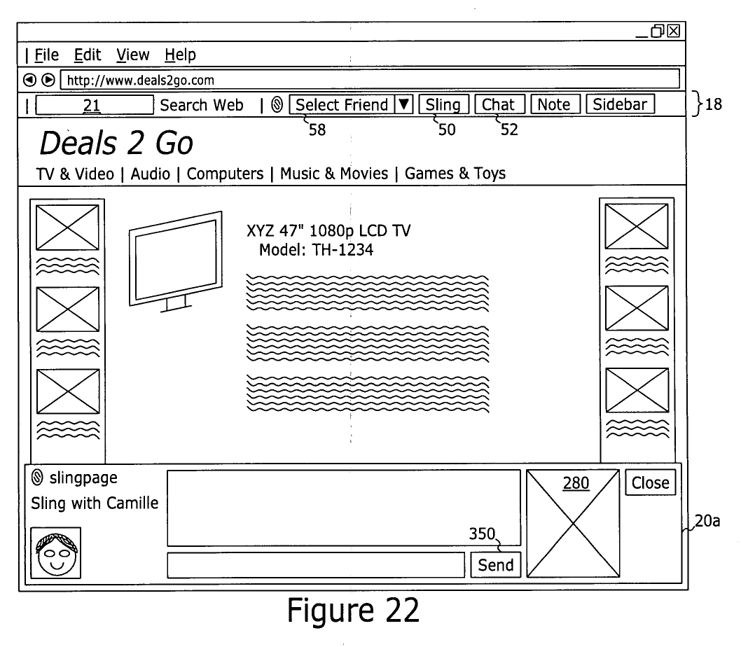

Turning briefly to FIG. 22, in conjunction with FIG. 16, the chatbar 20 may be rendered within, or associated with, a browser window 46 of each instance of the web browser operating on the client system 14. In the exemplary embodiment, the chatbar 20 may be rendered only in response to certain events which commence a chat session and, when rendered, may include a text window 250, a text entry control 256 (inclusive of a send control 350), a close window control 258, and at least one advertisement placement 280.

Returning to FIG. 16, the referral infrastructure system 12 generally includes a load balancing service 30, one or more lobby service systems 32, and one or more chat service systems 34 as the primary components with which clients 14a, 14b interface for purposes of sharing internet web pages, chatting, and otherwise participating in a social browsing session.

Each of the load balancing service system 30, lobby service system 32, and chat service system 34 may operate as a web server making certain callable methods available to each of the client systems 14a, 14b utilizing known technologies such as web services/simple object access protocols (SOAP) messaging and/or messaging over TCP/IP connections.

More specifically, the load balancing service 30 may make each of a Get_Lobby_ID method 302 and a Get_Chat_ID 304 method available to client systems 14. Each lobby service system 32 may make each of a Authenticate_User method 306, a Redirect_Invite method 308, and a Chat_Invite method 310 available to client systems. Each chat service system 32 may make each of a Get_Room_ID method 312 and a Relay_Text method 314 available to client systems.

In operation, the combination of the local referral module 17a, 17b installed on each of multiple client systems 14a, 14b and the described methods made available by components of the referral infrastructure system 12 provide a system for referring internet web pages, chatting, and otherwise participating in a social browsing session.

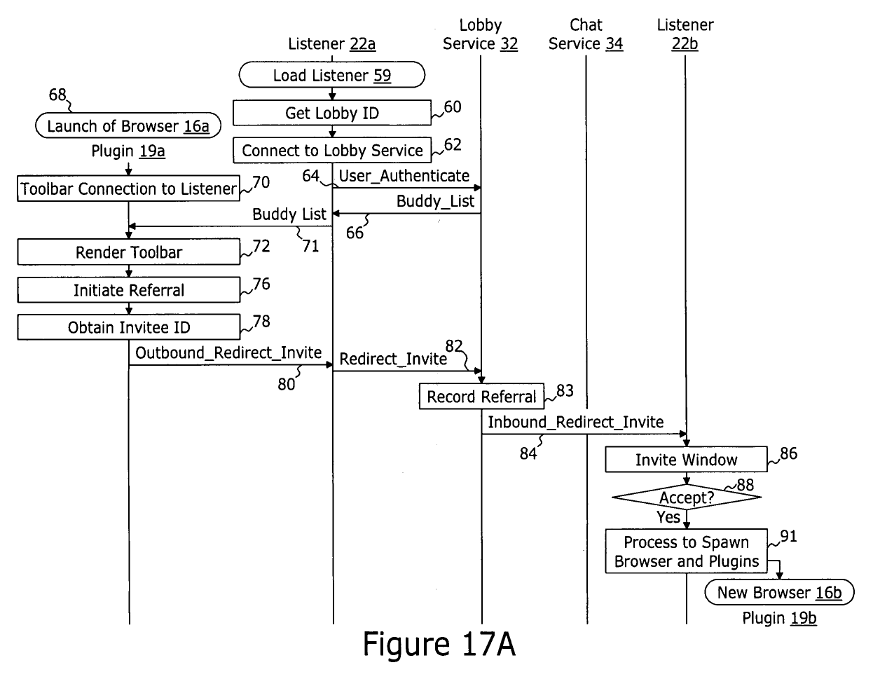

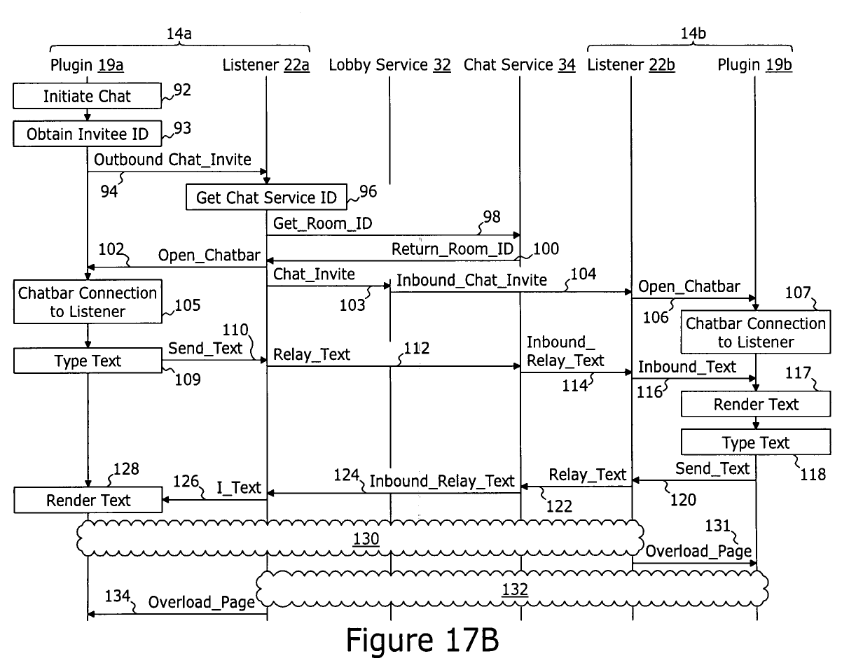

In more detail, referring to FIG. 17a in conjunction with FIG. 16, upon loading of the listener (for example loading of listener 22a on system 14a) as represented by step 59, the listener 22a may obtain a lobby ID identifying a lobby service system 32 to which the listener 22a is to connect. Obtaining the lobby ID is represented by step 60.

Because the referral infrastructure system 12 may comprise multiple lobby service systems 32, each of which supports a group of client systems 14, the Get_Lobby_ID method 302 made available by the load balancing server 30 may be called by a client system, for example client system 14a, for purposes of obtaining a lobby service ID (e.g. a unique identification (such as IP address) of a lobby service system 32 to which the client system 14a is to connect).

In response to a Get_Lobby_ID method call, the load balancing service 30 will generate a Return_Lobby_ID method call back to a Return_Lobby_ID method of the listener 22a. The Return_Lobby_ID method call may include the lobby ID.

After the listener 22a obtains a lobby ID identifying a lobby service system 32, the listener 22a may establish a persistent TCP/IP connection 28a with the identified lobby service system 32 as represented by step 62.

Upon establishing the TCP/IP connection 28a the listener 22a, may generate an Authenticate User method call to the Authenticate_User method 306 (step 64) for purposes of identifying the user of the client system 14a to the lobby service system 32.

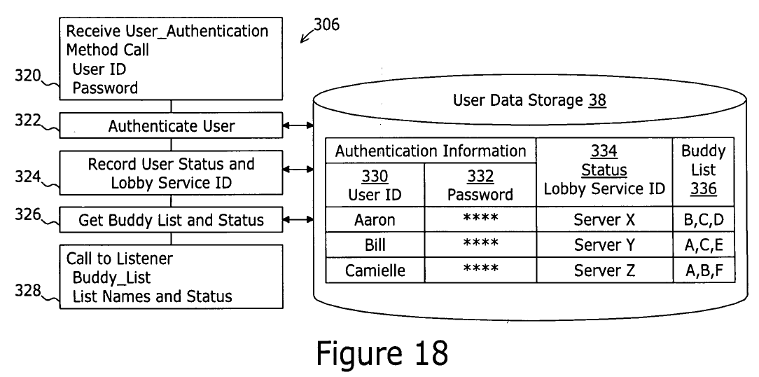

Turning to FIG. 18 in conjunction with FIG. 16, the Authenticate User method call may include a User ID uniquely identifying the user of the client system 14a and the user's password—as represented by box 320.

The Authenticate_User method 306 may be adapted to, in response to receipt of the Authenticate_User method call, authenticate the user by comparison of the authentication information provided in the method call (e.g. provided user ID and password) to authentication information comprising a user ID 330 and password 332 stored in a user data storage 38.

The lobby service system 32 may further update (represented by box 324) the registered users status 334 in the user data storage 38 to reflect that the user is logged-in. Further, user data storage 38 may identify the lobby service system 32 to which the registered user is connected if the implementation utilizes a centralized database for associating each logged in user with a supporting lobby service system. However, other methods may be used for associating a logged in user with a particular lobby service system 32 that do not require recording of such data in a central data storage. Examples include distributed system, and algorithmic systems.

The lobby service system 32 may further yet obtain a buddy list 336 associated with the registered user at step 326. In more detail, each registered user, for example registered user “Aaron” or “A” may be associated with one or more other registered users as part of Aaron's buddy list 336. In this example, Aaron's buddy list comprises at least registered users “B”, “C” and “D”. The user data storage 38 may also store the status of each registered user in the form of identifying whether the registered user is “off-line” or “on-line”.

The lobby service system 32 may, at step 328 generate a Buddy List method call (represented by box 328) back to a Buddy_List method made available by the listener 22a for purposes of providing the registered user's buddy list and the status of each buddy to the listener 22a. Returning to FIG. 17a in conjunction with FIG. 16, step 66 represents return of the buddy list to the listener 22a.

Upon launch of an instance of the web browser 16 (represented by step 68) the plug-in 19a may establish a toolbar TCP/IP connection 24a to the listener 22a as represented by step 70. Step 71 represents the listener 22a, in response to the connection 24a being established, providing the buddy list to the plug-in 19a for purposes of populating the buddy list control 58 of the tool bar 18a as depicted in FIG. 19. Step 72 represents rendering of the tool bar 18 in association with the newly spawned browser window 46.

For purposes of clarity, reference to an instance of the browser 16 or an instance of the browser window 46 is intended to also include an instance of a distinct tab in a browser implementation that includes tabs. Additionally, reference to an instance of the browser 16 or an instance of the browser window 46 may include any unique aspect of a browser application or a browser window distinguished from a separate aspect or window by a unique browser ID number.

Turning to FIG. 19 in conjunction with FIG. 17a, a first registered user, for example Aaron (the initiator), may, while browsing Internet web page content 56 within the browser window 46, activate the sling page or redirect control 50 (represented by step 76) for purposes of sharing the web page content 56 with a second registered user, for example Camielle (the invitee) of a different client system, for example client system 14b (the invitee system).

The plug-in 19a may further render the buddy list control 58 of the tool bar 18 for purposes of obtaining user identification of the invitee. More specifically, the buddy list control 58: i) lists other registered users, and groups, (potential invitees) which are associated with the initiator; ii) distinguishes between such potential invitees which are currently “on line” and those that are “off line”; and iii) enables user selection of an invitee from the potential invitees utilizing, for example, a pointer controlled highlight bar 59. Obtaining user selection of an invitee is represented by step 78.

Although FIG. 19 depicts the buddy list control 58 being rendered in response to user activation of the redirect control 50, other means for user initiating a redirect and selection of an invitee form a buddy list may include rendering of the buddy list along the side of the browser window and include a redirect control in association with each on-line buddy. Selection of such a control operates as both activation of the redirect control and selection of the invitee.

Following user selection of an invitee, the plug-in 19a may generate an Outbound Redirect Invite method call to the listener 22a over the toolbar TCP/IP connection 24a as represented by step 80. The Outbound Redirect Invite method call may include at least the location URL at which the web browser 16a is currently located (e.g. the URL where the web content 95 currently rendered was obtained).

In response thereto, the listener 22a may initiate a Redirect Invite method call (Step 82) a to the Redirect_Invite method 308 made available by the lobby service 32 to which the listener 22a has established the TCP/IP connection 28a for purposes of directing the lobby service system 32 to relay the URL of the web content 56 rendered within the initiator's browser window 46 to the invitee's client system 14b—such that an instance of the browser 16 on the invitee's client system 14b may be redirected to such URL for purposes of rendering such web content 56 to the invitee.

As will be discussed in more detail herein, the Redirect Invite method call may comprise at least: i) identification of the initiator by user ID (e.g. Aaron); ii) identification of the invitee by user ID (e.g. Camielle); and iii) the location URL (e.g. the URL of the web content 56 rendered within the initiator's browser window 46).

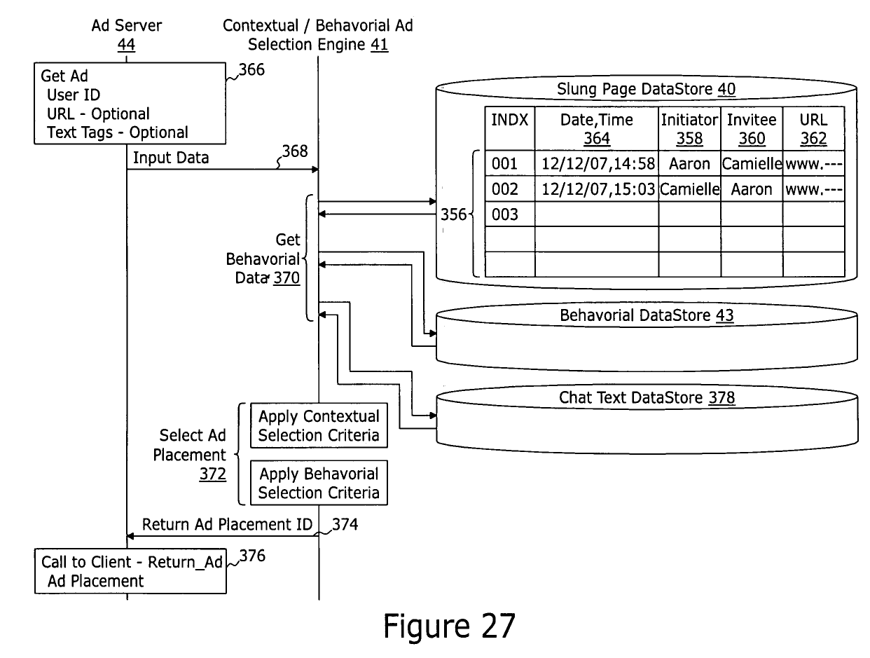

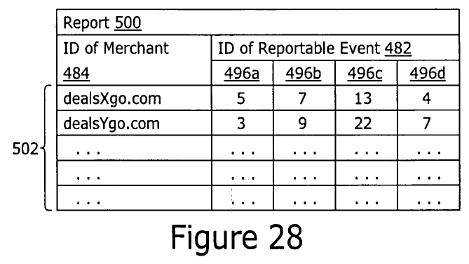

In response to receipt of the Redirect Invite method call, the lobby service 32 executes its Redirect_Invite method 308 which is adapted to record the redirect in the slungpage data storage 40 as depicted by step 83. Turning briefly to FIG. 27, recording the redirect in the slung page data storage may 40 may include writing a record 356 which associates identification of the initiator 358 (e.g. Aaron), identification of the invitee 360 (e.g. Camielle), identification of the location URL 362, and a date and time 364 at which the method call is processed by the lobby service system. As will be discussed in more detail, recording of slung page activity may be used for purposes of selecting relevant advertisement placements for rendering to either the initiator or the invitee.

Returning again to FIG. 17a in conjunction with FIG. 16, the Redirect_Invite method 308 is further adapted to: i) locate the invitee client system(s) 14b associated with the invitee or group of invitees (e.g. the TCP/IP connection 28b with the client system(s) 14b from which the invitee logged into the lobby server system 32); and ii) initiate an Inbound Redirect Invite method call to each invitee's client system 14b over the persistent TCP/IP connection 28b. The Inbound Redirect Invite method call is represented by step 84. As will be discussed in more detail herein, the Inbound_Redirect_Invite method call comprises at least: i) identification of the initiator by user ID (e.g. Aaron); ii) identification of the invitee by user ID or group ID (e.g. Camielle); and iii) the location URL. Further, it is envisioned that the location URL may be provided in association with appended data identifying the referral infrastructure system 12, or an operator of the referral infrastructure system 12 such that a web server providing web content at the URL may associated the connection request from the target client system with the referral infrastructure system 12 or the operator of the referral infrastructure system 12.

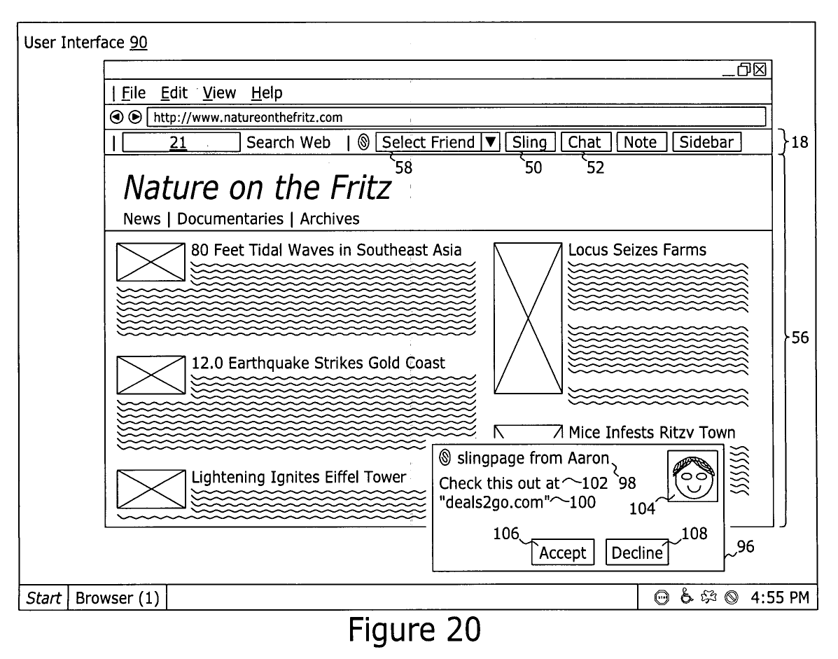

Turning briefly to FIG. 20, a graphical user interface 90 of the invitee's client system 14b is depicted. The graphical user interface 90 may include typical interface controls inclusive of system tray icons 92. The system tray icons 92 may include a Slingpage icon 94. The graphical user interface 90, in a traditional manner, may also include open windows for active applications as represented by browser window 46 depicting web content 95. With reference to FIG. 10 in conjunction with FIG. 17a, upon receipt of the Inbound Redirect Invite method call, the listener 22b of the client system 14b may render an invite notification window which may be implemented as a system tray slider window 96. Rendering the invite window 96 is represented by step 86.

Depicted in the invite notification window 96 may be an initiator identification 98 identifying the initiator by user ID (e.g. Aaron), a URL identification 100 identifying the location URL and/or web content that the initiator desires to share; a message text 102 (which may be input by the initiator and passed as part of the Redirect Invite method call and the Inbound Redirect Invite method call); and other information such as a thumbnail photograph 104 of the initiator. The invite notification window 96 may further include an acceptance control 106 and a decline control 108. The decline control 108 may simply close the invite notification window.

Returning to FIG. 17a, in response to the invitee activating the acceptance control (depicted by decision box 88), the listener 22b calls a function of the operating system (such as process.start in the Microsoft Windows environment) to spawn a new browser 16b and direct such new browser 16b to the location URL (represented by step 91) for purposes of rendering the same web content 56 as rendered in the initiators browser window 46 (FIG. 19) at the time of initial activation of the slingpage control 50.

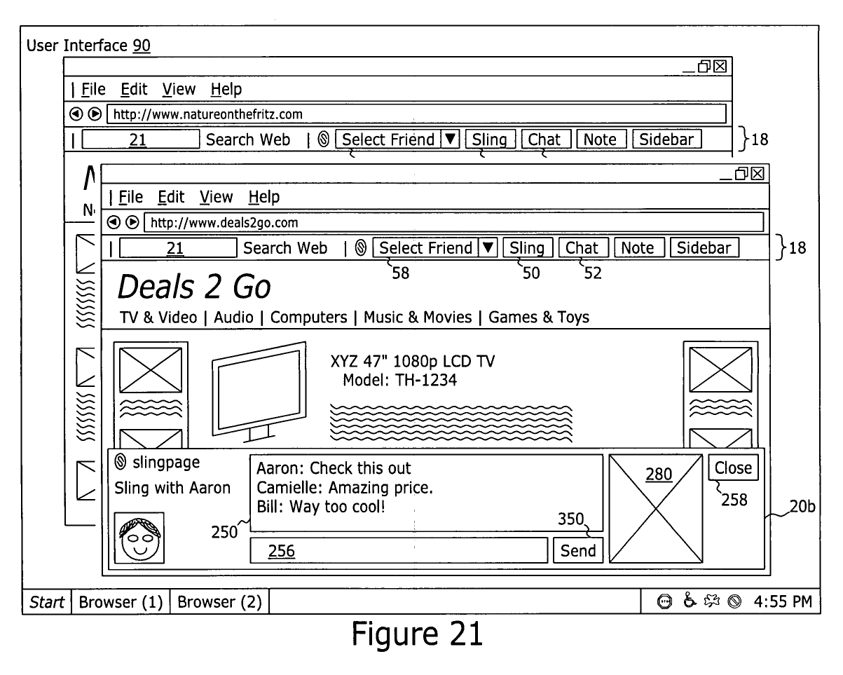

Following the spawning of the new browser 16b within the invitee's user interface 90, as depicted in FIG. 21, each of the initiator and the invitee are viewing the same web content 56.

Returning briefly to FIG. 16 in conjunction with FIG. 18, it should be appreciated that although only a single lobby service 32 is depicted in FIG. 16, a typical implementation will include multiple lobby service systems 32. It is envisioned that the initiator client system 14a and the invitee client system 14b may have TCP/IP connections 28a, 28b established with different lobby service systems 32.

To enable listener 22a to initiate the Redirect Invite method call to the particular lobby service system 32 with which it is connected (e.g. server X) and have a different lobby service system 32 which listener 22b is connected (e.g. server Y) initiate the Inbound Redirect Invite method call, a lobby messaging sub system 36 (which may be a combination of persistent TCP/IP connections between the various servers) may enable passing of method calls between the multiple lobby service systems 32.

In one aspect, the user data storage 38 may identify the particular lobby service system with which the user is connected within the status field 334 (for example Aaron is supported by server X while Camielle is supported by Server Y. As such, each lobby service may access the user data storage 38 for identifying the lobby service supporting the invitee. In other aspects, such information may be distributed to all lobby service system or, if each registered user is assigned to a lobby service system using a particular hash algorithm, each lobby service system may independently operate such hash algorithm to identify the lobby service supporting the invitee.

In addition to the steps discussed with respect to FIG. 17a for purposes of rendering common web content 56 within browser window 46 of each of the initiator client system 14a and the invitee client system 14b. It is envisioned that establishing a corresponding chat session between the browser windows 46 depicting the common web content 56 facilitates a social browsing experience. The chat session may be set up in conjunction with the exemplary steps for slinging a web page from client system 14a to client system 14b (e.g. the exemplary steps discussed with respect to FIG. 17a) or, with reference to FIG. 19 in conjunction with FIG. 17b, the chat session may be set up following the user activating the chat control 52 independent of activation of the redirect control 50.

In more detail, and referring to the diagram of FIG. 17b, in response to activation of the redirect control 50 and/or in response to independent activation of the chat control 52 (represented by step 92), the plug-in 19a may display the buddy list control 58 for purposes of identification of an invitee (or again, a group). In the event that the user has activated the redirect control 50, user identification of an invitee may be for purposes of both purposes of the redirect process discussed with respect to FIG. 17a and for purposes of setting up the chat session. In either event, obtaining user selection of an invitee is represented by step 93.

Following user selection of an invitee, the plug-in 19a may initiate an Outbound Chat Invite method call to the listener 22a (represented by step 94) utilizing the toolbar connection to the listener 22a (e.g. connection 24a as depicted in FIG. 16). The Outbound Chat Invite method call may comprise at least identification of the invitee.

In response to receipt of the Outbound_Chat_Invite method call, the listener 22a obtains a chat service ID identifying a chat service system to 34 to which the listener 22a may connect for purposes of supporting the chat session. In more detail, and with reference to FIG. 16 in conjunction with FIG. 17b, because the infrastructure systems 12 may comprise multiple chat service systems 32, each of which supports multiple chat sessions between client systems 14, the Get_Chat_ID method 304 may be called by a client system, for example client system 14a, for purposes of obtaining identification of a chat service system 34 to which the client system 14a is to connect for purposes of a chat session with another client. In response to a Get_Chat_ID method call, the load balancing service 30 will generate a Return_Chat_ID method call back to a Return_Chat_ID method on the client system 14a. The Return_Chat_ID method call may include a chat room ID identifying (for example by unique IP address) of a chat service system 34 to which the client 14a is to connect. Obtaining the chat service ID is represented by step 96.

After obtaining the chat service ID, the listener 22a may establish a TCP/IP connection 29a to the identified chat service 34 and through such TCP/IP connection 29a, initiate a Get_Room_ID method call (represented by step 98) to the Get_Room_ID method 312 made available by the chat service 34.

The chat service 34 may initiate a Return Room ID method call to a Return_Room_ID method made available by listener 22a for purposes of providing a unique Room ID such that each client participating in the chat session may, by inclusion of the unique Room ID in Relay_Text method calls, effect relay of text to the other client(s) participating in the chat session. Return of the unique Room ID is represented by step 100.

Upon receipt of the unique room ID, the listener 22a may generate an Open Chatbar method call to the plug-in 19a as represented by step 102. The Open Chatbar method call may include the chat resource information inclusive of the chat service ID identifying the chat service system 34 and the unique Room ID.

In response to receipt of the Open Chatbar method call, the browser plug-in may: i) direct rendering (e.g. pop up) of the chatbar 20 within, or associated with, the initiators browser window 46 as depicted in FIG. 22; and establish the chatbar connection 26a (FIG. 16) to the listener 22a for support of the chat session. Such processes are represented by step 105.

Referring again to FIG. 16 in conjunction with FIG. 17b, also in response to receipt of the unique room ID, the listener 22a may generate a Chat Invite method call to the Chat_Invite method 310 made available by the lobby service 32 over the TCP/IP connection 28a for purposes of passing identification of the chat service system 34 and a chat room ID to each invitee's client system 14b. The chat invite method call is represented by step 103. As will be discussed in more detail herein, the Chat Invite method call comprises at least: i) identification of the invitee or group; ii) the chat service ID; and the chat room ID. Identification of the initiator may also be included in the Chat Invite method call.

In response to receipt of the Chat Invite method call the lobby service 32 may initiate an Inbound Chat Invite method call to the listener 22b of each invitee client system 14b over the TCP/IP connection 28b therewith. The Inbound Chat Invite method call is represented by step 104. As will be discussed in more detail herein, the Inbound Chat Invite method call may comprise the same information as the Chat Invite method call.

Upon receipt of the Inbound Redirect Invite method call the listener 22b: i) opens a TCP/IP connection 29b with the chat service 34 identified in the Inbound Redirect Invite method call 64; and ii) generates an Open Chartbar method call to the plug-in 19b. Similar to operation of the plug-in 19a, the plug-in 19b may: i) directs rendering (e.g. pop up) of the chatbar 20b within, or associated with, the invitee's browser window 46 as depicted in FIG. 21; and establish the chatbar connection 26b (FIG. 16) to the listener 22b for support of the chat session. Such processes are represented by step 107.

It should be appreciated that although the exemplary embodiment provides for rendering of each chatbar 20 within the browser window 46, rendering of a chatbar independent of the browser window is also envisioned.

Following the opening of each chatbar 20, text typed by each user is exchanged between the participating client systems 14a, 14b by initiating Relay Text method calls to the Relay_Text method 314 (FIG. 16) of the chat service system 34.

More specifically, referring to FIG. 22 in conjunction with FIG. 16 and FIG. 17b, upon user activation of a send control 350 of the chatbar 20a, the chatbar 20a initiates a Send Text method call to its listener 22a over the chatbar TCP/IP connection 26 as represented by step 110. The Send Text method call comprises at least the chat service ID, the unique room ID, and the text to be relayed.

In response to receipt of the Send Text method call, listener 22a initiates a Relay Text method call the Relay_Text method 314 made available by the chat services system 34 over the TCP/IP connection 29a established therewith. The Relay Text method call is represented by step 112. The Relay Text method call comprises at least the unique Room ID and the text to be relayed.

In response to the Relay Text method call, chat services 34 generates an Inbound Text method call to each listener 22b of clients participating in the chat room over TCP/IP connection 29b as represented by step 114. In turn, the listener 22b generates an Inbound Text method call to the plug-in 29b over the chatbar TCP/IP connection 26b as represented by step 116. The plug-in then renders the text received in the Inbound Text method call within the chatbar 20b as represented by step 117.

Similarly, text typed into chatbar 20b (as represented by step 118) may be sent for rendering in chatbar 20a following a similar process of the plug-in 19b generating a Send Text method call to the listener 22b (step 120), the listener 22b generating a Relay Text method call to the chat service 34 (step 122), the chat service 34 generating an Inbound Relay Text method call to each listener 22a (step 124), the listener 22a generating an Inbound Text method call to the plug-in 19a (step 126), and the plug-in 19a rendering the text as represented by step 128.

Further yet, additional web content may be exchanged between the users for the duration of a social-browsing session. More specifically, an initiator (again using toolbar client system 14a as the exemplary initiating client system) may initiate sending of Internet web site additional content to the invitee (again using client system 14b as the exemplary invitee client system). Upon user activation of the redirect control 50, the Outbound_Redirect_Invite method call to the listener 22a, the Redirect_Invite 62 to the lobby service 32, and the Inbound_Redirect_Invite 64 to the listener 22b of the invitee will be generated as discussed above (represented by cloud box 130). However, to further provide the experience of a social browsing session, it is envisioned that in the event the initiator activates the redirect control 50 in a browser window 46 which includes (or is associated with) an activate chatbar 20, the default invitee may be the registered user with which the chat session is open.

Similarly, the listener 22b, after receiving an Inbound_Redirect_Invite method call may not utilize a processing call to the operating system to spawn a new browser if an existing browser window 46 includes (or is associated with) a chat session with the initiator identified in the Inbound_Redirect_Invite method call. Instead, the listener 22b may instead initiate an Overload_Page method call to the plug-in 19b of such existing browser window 46 over the tool bar TCP/IP connection 24. The Overload_Page method call 120 comprises at least the location URL provided in the Inbound Redirect Invite method call.

In response to receiving the Overload_Page method call, the plug-in 19b may initiate a call to a navigate to URL method of the web browser's plug-in API for purposes of redirecting the browser to the location URL.

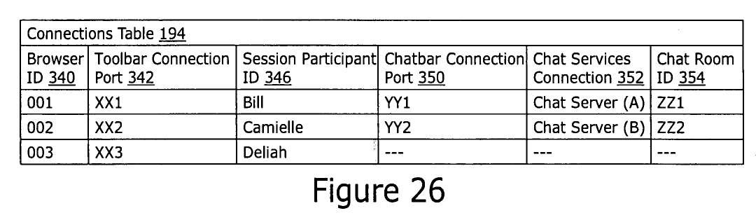

More specifically, referring briefly to FIG. 26, a connections table 194 (maintained by each listener 22) may associate each active instance of the browser (by browser ID 340) with: i) a tool bar connection port ID 342 identifying the toolbar connection 24; ii) a session participant ID 346 identifying the other registered user to which, or from which, pages have been slung in accordance with the steps of FIG. 17a and/or a chat session has been established in accordance with the steps of FIG. 17b; iii) a chatbar connection port ID 350 identifying the chatbar connection 26 (if any); iv) a chat services ID 354 identifying the chat services system 34 (if any) supporting the chat session (if any); and v) a chat room ID 354 identifying the unique chat room assigned for supporting the chat session (if any).

When an Inbound Redirect Invite method call is received, if the initiator identified in the method call is the session participant 346 associated with an existing instance of the browser—as identified in the connections table 194, the listener 22b may initiate the Overload Page method call to the plug-in 19b of such existing instance of the browser.

Returning to FIG. 17b, the user of client system 14b may initiate sending of additional Internet web site content to the user of client system 14a. Upon user activation of the redirect control 50, an Outbound Redirect Invite method call to the listener 22b, a Redirect Invite method call to the lobby service 32, and an Inbound Redirect Invite method call to the listener 22a will be generated. Such processes are represented by cloud box 132.

Again, assuming that the client system 14a includes an existing browser window 46 that includes (or is associated with) a chat session with the client system 14b, the client system 14a may initiate an Overload_Page method call (step 134) to the plug-in 19a of such existing browser window 46 over the tool bar TCP/IP connection instead of opening a new browser window utilizing the process.start call.

Again, in the event that the control status 348 of the connections table 194 indicates that the user has activated the auto accept control 54 of the browser window 46, the listener 22a may initiate the Overload_Page method call (step 134) directly in response to receipt of the Inbound_Redirect_Invite method call without intervening processes of generating an invite window.

Further yet, referring again to FIG. 21 in conjunction with FIG. 16, for purposes of generating revenue by placements of advertisements (i.e. monetizing by placement of advertisements), periodically during the duration of the social browsing session, each listener 22 may initiate a Get Ad method call to the ad server 44 of the social browsing infrastructure systems 12.

Turning briefly to FIG. 27 in conjunction with FIG. 16, the Get Ad method call may includes at least the user ID of the registered user of the system 14. Further, the Get Ad method call may optionally include identification of a recently slung location URL and/or identification of a portion of a web page being rendered by an instance of the browser, for example text tags extracted from the web page. Step 366 represents receipt of the Get Ad method call.

In response to the Get Ad method call, the ad server 44 may input such data elements to a contextual/behavioral selection engine 41 as represented by step 368. The selection engine 41 may reference the slung page data store 40 for purposes of identifying one or more web pages (by URL) that have been slung to the user, or slung by the user, within a recent time period. As discussed, the lobby service system 32 may initiate writing of a record 356 to the slung page data store 40 each time a Redirect Invite method call is received.

Further, the selection engine 41 may: i) reference a behavioral data storage 43 for obtaining information related to both the initiator and the invitee; and ii) reference a chat text data store 378 for obtaining chat text of the initiator and the invitee (or their associated buddies) related to recently slung pages (as identified in the slung page data store 40). Referencing the slung page data store 40, the behavioral data store 43, and the chat text data store 378 are resented by step 70.

Further yet, the selection engine 41 may apply contextual selection criteria and/or behavioral selection criteria—utilizing any combination of data obtained from the slung page data store 40, the behavioral data store 43, and the chat text data store 378 to identify a relevant advertisement as represented by step 372 and, as represented by step 374, return an ad placement ID identifying such relevant advertisement placement to the ad server 44.

The ad server 44 initiates a Return Ad method call to the listener 22 of the client system 14 at step 376. The Return Ad method call includes the ad placement and, in response thereto, the listener 22 initiates rendering of the ad placement in association with the browser 16. Such rendering may be by way of rendering the ad placement within a frame 280 of the chatbar (FIG. 21).

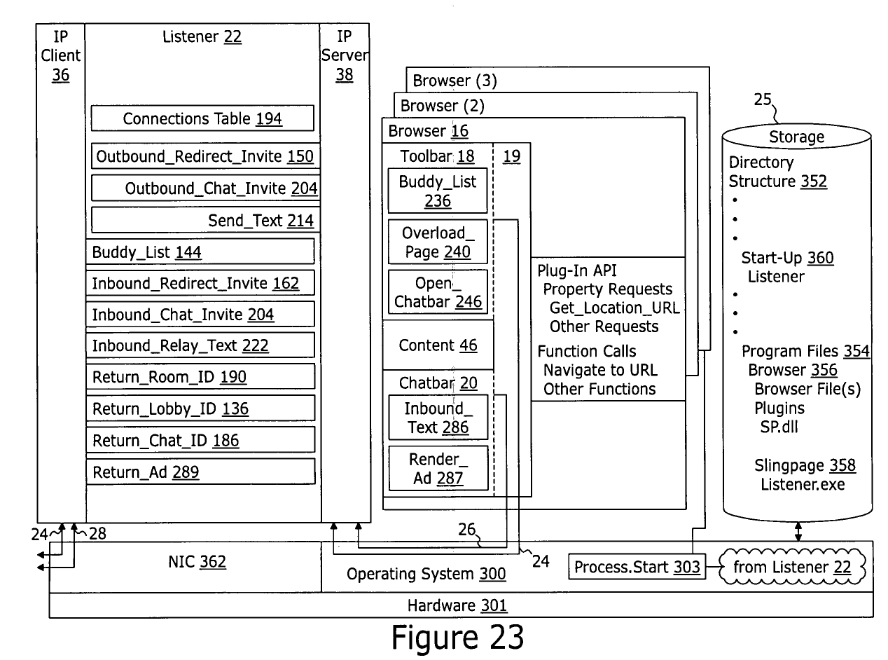

FIG. 23 depicts a more detailed block diagram of a client system 14 configured to facilitate social browsing in accordance with the present invention. The client system 14 may comprise a networked computing device with web browsing functions such as a desk top computer, a note book computer, a mobile telephone, PDA, or other similar device.

In general, the client system 14 includes various hardware systems 301 including network interface circuitry 362 for providing lower level communication services for establishing the TCP/IP connections 24 and 28 with the infrastructure systems 12 over the Internet. The client 14 further includes an operating system 300 local storage (such as a hard drive) 25, the web browser application 16, and the local component represented by the listener 22 and the plug-in component 19—inclusive of the toolbar 18 and the chatbar 20.

In more detail local storage or hard drive 25 stores a plurality of files in a traditional directory structure 352. For purposes of illustrating the present invention, the directory structure 352 may comprises a directory for storage of program files—typically called program files directory 354. Within the program files directory 354 may be a web browser sub directory 356 and a slingpage subdirectory 358.

The web browser sub directory 356 may include one or more web browser files and/or directories comprising one or more web browser files which, when loaded to executable memory spawns an instance of the web browser 16, inclusive of plug in 19 and any other plug-ins identified in the applicable registry.

The slingpage subdirectory comprises one or more listener files which, when loaded to executable memory, spawns the listener 22.

The operating system 300 may be a traditional operating system such as Windows XP available from Microsoft Corporation. Amongst other functions provided by the operating system 300 the operating system 300 includes a function of loading, upon system start up, those applications identified in a Start Up directory 360 of the directory structure 352. For purposes of illustrating the present invention, at least listener 22 may be identified in the start up directory such that listener 22 is loaded upon system start up.

The operating system 300 further provides TCP/IP services enabling TCP/IP client applications to establish TCP/IP connections with TCP/IP server application. More specifically, for purposes of this invention: i) the TCP/IP services and networking hardware 362 enable the browser 16 and a TCP/IP client application 36 of the listener 22 to establish TCP/IP connections with remote TCP/IP server systems such as the Infrastructure systems 12; and ii) the TCP/IP services enable TCP/IP client functions of toolbar 18 and chatbar 20 to establish local TCP/IP connections with a TCP/IP server application 38 of listener 22.

The operating system may provide the Process.Start function 303 which, as discussed, may be a function available to be called by listener 22 for purposes of spawning a new instance of browser 16 and directing such new instance of browser 16 to a specified URL.

Each Browser system 16 inclusive of installed plug-in 19, includes a plug-in API 353 making typical property requests and function calls available to installed plug-ins such as plug-in 19. For purposes of illustrating the present invention: i) the property requests include at least a Get_Location_URL property request which, in response to receipt therefore from the plug-in 19, the browser 16 returns identification of the URL from which the current rendered web content was obtained; and ii) the function calls include at least a Navigate_To_URL function which, in response to receipt thereof from the plug-in 19, the browser connects to a URL identified in the function call and overloads current content with content obtained from the URL.

As discussed with respect to FIG. 16, each plug-in 19 comprises a tool bar 18 and a chatbar 20. Amongst other functions, the plug-in 19 makes at least the following methods available for calling by the locally installed listener 22: i) a Buddy_List method 236; ii) an Overload_Page method 240; iii) an Open_Chatbar method 246, and Inbound_Text method 286; and iv) a Render Ad method 287.

The listener 22 includes an IP server system 38 for establishing and maintaining, for each instance of the browser 16, tool bar TCP/IP connection 24 and the chatbar TCP/IP connection 26.

The listener 22, amongst other function, makes the following methods available for calling by plug-in 19 over such TCP/IP connections 24 and 26: i) an Outbound_Redirect_Invite method 150; ii) an Outbound_Chat_Invite method 204; and iii) a Send_Text method 214.

Referring to FIG. 23 in conjunction with FIG. 16, the listener 22 includes an IP client system 36 for establishing and maintaining IP connections with the remote infrastructure systems 12 and, in particular, the TCP/IP connection 28 with a lobby service system 32 and TCP/IP connection 29 with a chat service system 34.

The listener 22, amongst other function, makes the following methods available for calling by the remote infrastructure systems 12: i) a Buddy_List method 144 (discussed with respect to FIG. 19); ii) an Inbound_Redirect_Invite method 162; iii) an Inbound_Chat_Invite method 204; iv) an Inbound_Relay_Text method 222; v) a Return_Room_ID method 190; vi) a Return_Lobby_ID method 136; vii) a Return_Chat_ID method 186; and viii) a Return_Ad method 289.

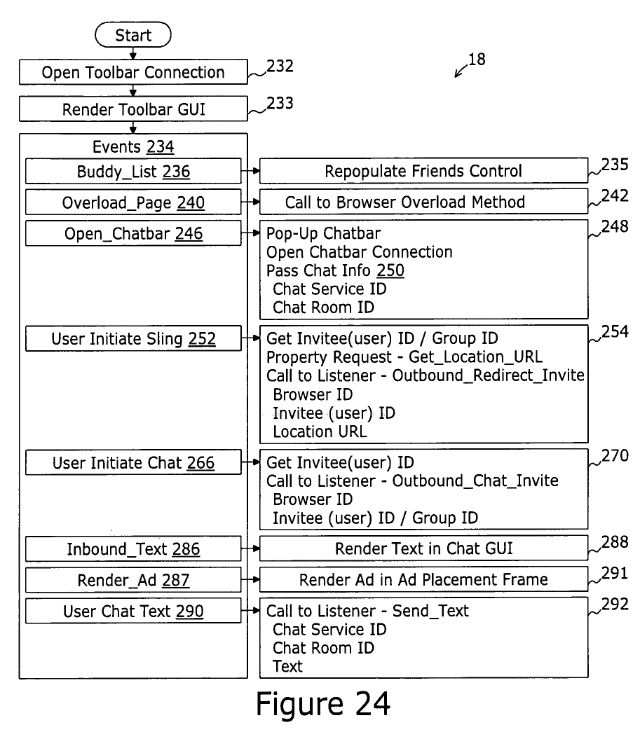

FIG. 24 depicts exemplary operation of the plug-in 19—inclusive of the methods discussed with respect to FIG. 23. Referring to FIG. 24 in conjunction with FIG. 23, upon the operating system 300 spawning a new instance of the browser 16, the plug-in 19 inclusive of the plug-in component 19, opens the toolbar TCP/IP connection 24 to the listener 22 operating on the client system 14 and renders the tool bar GUI 18. These processes are represented by box 232 and box 233 respectively.

Thereafter, the plug-in 19 makes the various methods available for calling by the listener 22. Such methods include the Buddy_List method 236, the Overload_Page method 240, the Open_Chatbar method 246; the Inbound_Text method 286; and the Render_Ad method 287.

Further, the plug-in 19 may perform certain functions (inclusive of initiating certain method calls to the listener 22) in response to user interaction events with the tool bar 18 or the chatbar 20. With respect to the tool bar 18, these user interaction events include: i) the user initiating a referral 252 (e.g. activating the redirect control 50); and ii) the user initiating a chat 266 (e.g. activating the sling page control 50 and/or the chat control 52). With respect to the chatbar 20, the user interaction events include the user entering chat text and activating the send control (FIG. 21).

The Buddy_List method 236 includes a process 235 which represents populating, or repopulating, the list of friends (e.g. user ID for each friend) in the buddy control 58 (FIG. 19), and the status of each, in accordance with those buddy's and their status identified in the Buddy List method call provided by the listener 22. This process is represented by box 235.

The Overload_Page method 253 includes a process 242 which represents initiating a call to the web browsers navigate to URL method for purposes of directing the browser to the URL included in the Overload Page method call received from the listener 22.

The Open_Chatbar method 246 includes functions of: i) opening the chatbar 20 within the browser window or otherwise generating the chatbar GUI 20 (FIG. 22) in association with the web browser; and ii) passing chat resource information to the newly rendered chatbar 20 to enable the newly spawned chatbar 20 to send and receive text. The chat resource information may include at least the Chat Service ID and the Chat Room ID. These function are represented by box 248.

The Inbound_Text method 186 includes a function of rendering the text in the chatbar GUI 20 (FIG. 22). The function is represented by box 288.

The Render_Ad method 287 includes a function of rendering the ad within a placement window 280 in association with the browser—which may be a placement window 280 within the chatbar 20 as depicted in FIG. 21.

Functions performed in response to the user initiating a referral 252 (e.g. activating the sling page control 50) include: i) obtaining identification of the Invitee (by user ID) by means of rendering the buddy list GUI 58 (FIG. 19) and obtaining user selection of the selected buddy; ii) generating a Get_Location_URL property request to the plug-in API of the browser 16 for purposes of obtaining the URL from which the web content 46 currently rendered by the browser was obtained. This web content 46 may be referred to as the location URL or the location URL to which the remote browser is intended to be redirected.

After obtaining the Invitee ID and the location URL, the tool bar 18 initiates the Outbound Redirect Invite method call to the listener 22. The Outbound Redirect Invite Method call includes at least the browser ID, the Invitee ID, and the Location URL. These function are represented by box 254.

Functions performed in response to the user initiating chat 266 include: i) obtaining identification of the Invitee (by user ID) by means of rendering the buddy list GUI 58 (FIG. 19) and obtaining user selection of the selected buddy; and ii) initiating the Outbound chat Invite method call to the listener 22. The Outbound Chat Invite method call includes at least the browser ID and the invitee ID. Such functions are resented by box 270.

Functions performed in response to the user giving control of a web browser window to a buddy 276 include: i) obtaining identification of the Invitee (by user ID) to which control is to be given; and ii) initiating the Give Control method call to the listener 22. The Give Control Method call includes at least the browser ID and the Invitee ID. In an situation where the instance of the browser already includes, or is associated with, an open chatbar GUI 20 (FIG. 22), the Invitee ID may be, by default, the ID of the user with which chat session exists. These function are represented by box 278.

The functions performed in response to the user typing chat text into the chatbar GUI 20 includes the Send Text method call to the listener 22. The Send Text method call includes at least the Chat Server ID, Chat Room ID, and the typed text. These function are represented by box 292.

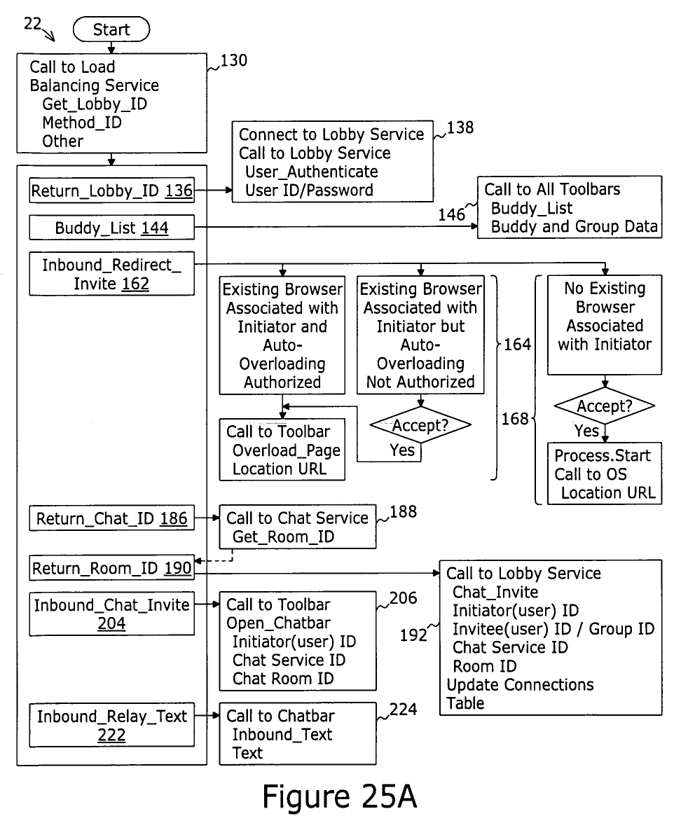

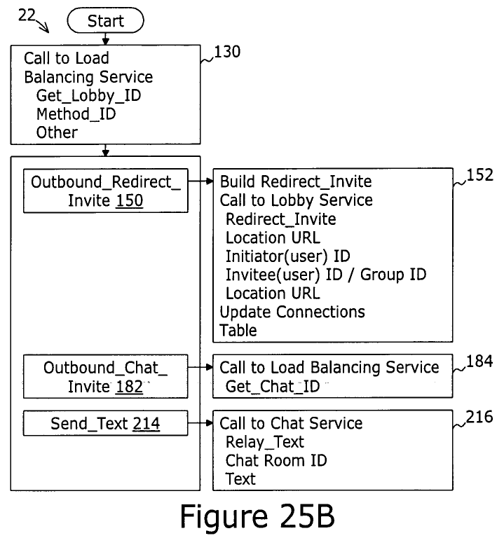

FIGS. 25a and 25b depict exemplary operation of the listener 22—inclusive of the methods discussed with respect to FIG. 23. Referring to FIG. 25a in conjunction with FIG. 16, upon the operating system 300 loading the listener 22 into memory for execution, the listener generates a Get Lobby ID method call to the load balancing service using predetermined load balancing service connection information stored on the client system 14. This method call is represented by step 130.

Thereafter, the listener 22, through the IP client 36, makes various methods available for calling by the remote infrastructure systems 12 with which the listener 22 has established a TCP/IP connection—including the load balancing service 30, lobby service system 32, and chat services system 34. These methods include: i) the Return_Lobby_ID method 136; ii) the Return_Chat_ID method 186; iii) the Return_Room_ID method 190; iv) the Inbound_Redirect_Invite method 162; v) the Inbound_Chat_Invite method 204; vi) the Buddy List method 144; vii) the Inbound_Relay_Text method 222; and viii) the Return_Ad method 289.

The Return_Lobby_ID method 136, in response to a Return Lobby ID method call from the load balancing server 30 is adapted to: i) establish the TCP/IP connection 24 to the identified lobby services system 32; and ii) initiate the Authenticate_User method call to the lobby service system 32. These functions are represented by box 138.

The Buddy_List method 144, in response to receipt of a Buddy_List method call from the lobby service system 32 is adapted to generate a local Buddy List method call to each toolbar 18 operating on the local system 14.

The Inbound_Redirect_Invite method 162, in response to receipt of an Inbound Redirect Invite method call from the lobby service system 32 is adapted to, if there is no existing browser open that is associated with the initiator (e.g. an existing social browsing session with the initiator as recorded in the connections table 194 depicted in FIG. 26) and render the invite window 96 as depicted in FIG. 20 for purposes of soliciting the user's acceptance of the inbound redirect.

If the user accepts the inbound redirect, the listener 22 calls the applicable method (such as process.start) of the operating system 300 for purposes of spawning a new instance of the browser 16 and directing such new instance of the browser 16 to load the web content available at the predetermined location URL included in the Inbound Redirect method call. These functions are represented by reference numeral 168.

Alternatively if a record in the connections table 194 (FIG. 26) indicates that there is an existing browser 16 associated with the initiator identified in the Inbound Redirect Invite method call, the listener 22 may: i) render the invite window 96 (as depicted in FIG. 20) for purposes of soliciting the user's acceptance of the inbound redirect and, upon user acceptance, initiate the Overload Page method call to the toolbar 18 of such browser; or ii) if the control status 348 of such record in the connections table 194 indicates that the user has activated the auto accept control 54 within such existing browser 16, simply initiate the Overload Page method call to the toolbar 18 of such browser. These functions are represented by reference numeral 164.

The Return_Chat_ID method 186, in response to receipt of a Return Chat ID method call from the load balancing server 30 is adapted to, i) establish the TCP/IP connection 24 to the identified chat services system 34, and ii) initiate the Get Room ID method call to the chat service system 34. These functions are represented by box 188.

The Return_Room_ID method 190, in response to receipt of a Return Room ID method call from the chat service system 34 is adapted to, i) initiate the Chat Invite method call to the lobby services system 32; ii) initiate the Open Chatbar to the instance of the toolbar 18 initiating the chat session; and iii) update the applicable fields of the connections table 194 (FIG. 26). These function are represented by box 192.

The Inbound_Chat_Invite method 204, in response to receipt of an Inbound Chat Invite method call from the lobby service system 32, is adapted to: i) initiate the Open Chatbar method call to the instance of the toolbar 18 associated with the initiator of the chat session (as depicted in the connections table 194); and iii) update the applicable fields of the connections table 194 (FIG. 26). These functions are resented by box 206.

The Inbound_Relay_Text method 222, in response to receipt of an Inbound Relay Text method call from the chat service system 34, is adapted to: i) initiate the Inbound Text method call to the chatbar 20 associated with the chat session in the connections table 194 (FIG. 26). This function is represented by box 224.

The Return_Ad method 289, in response to receipt of a Return Ad method call from the ad server 44, is adapted to render the advertisement placement in conjunction with the instance of the web browser. Such rendering may be by want to initiating a call to the plug in 19 for rendering the ad placement within an ad frame 280 of the chatbar 20.

Returning again to FIG. 23, the listener 22 also, through the IP server 38, makes various methods available for calling by local instances of the plug in 19, inclusive of the toolbar 18 and/or the chatbar 20, that have established local tool bar or chatbar TCP/IP connections to the listener 22. These methods include: i) the Outbound_Redirect Invite method 150; ii) the Outbound_Chat_Invite method 204; and iii) the Send_Text method 214,

Referring to FIG. 25b in conjunction with FIG. 23, the Outbound_Redirect_Invite method 150, in response to an Outbound Redirect Invite method call from a toolbar 18, is adapted to: i) look up the information required for initiating the Redirect Invite method call to the lobby service system 32; ii) initiate the Redirect Invite method call to the lobby service system 32; and iii) update the connections table 94 (FIG. 26). This function is represented by box 152.

The Outbound_Chat_Invite method 182, in response to an Outbound Chat Invite method call from a toolbar 18, is adapted to: i) initiate the Get Chat ID method call to the load balancing server 30; and iii) update the connections table 94 (FIG. 26). This function is represented by box 184.

The Send_Text method 214, in response to a Send Text method call from a chatbar 20, is adapted to: i) initiate the Relay Text method call to the chat service system 34 as represented by box 216.

The Auto_Accept method 182, in response to a Give Control method call from a toolbar 18, is adapted to update the control status 348 of the browser in the connections table 194 (FIG. 26) as represented by box 230.

Although the invention has been shown and described with respect to certain exemplary embodiments, it is obvious that equivalents and modifications will occur to others skilled in the art upon the reading and understanding of the specification. For example, although the system described with respect to FIGS. 16 through 23 is useful for implementing the referral of web pages in accordance with the present invention, those skilled in the art will recognize that alternative embodiments and other systems may be used to implement referrals. As another example, data relationships represented in various figures are exemplary only. Further, those skilled in the art will appreciate that database design may utilize other data relationships to achieve the objectives of the present invention. The present invention includes all such equivalents and modifications, and is limited only by the scope of the following claims.

What is claimed is:

1. A system for monetizing the referral of a web pages, the system comprising a source client system, at least one target client system, a referral server, and an accounting server:
the source client system being operated by a first user and comprising:
a source web browser adapted to render an advertising merchant's web page; and
a source referral module coupled to the source web browser and being adapted to, in response to user selection of at least one target client, generate a referral message to the referral server, the referral message identifying at least one target client and the advertising merchant's web page;
the referral server adapted to:
provide a referral instruction to a target client system, the target client system being distinct from the source client system and being operated by one of the identified target clients, the referral instruction comprising identification of the advertising merchant's web page; and
the target client system, the target client system comprising:
a target referral module adapted to:
receive the referral message and render a window prompting the target client to one of accept and decline the referral message;
upon the target client accepting the referral message, pass identification of the advertising merchant's web page to a target web browser, the target web browser rendering the advertising merchant's web page on the target client system; and
generate an informational message upon the execution of a revenue event by the target client system, the revenue event being an event selected from a group of events consisting of: i) rendering the advertising merchant's web page on the target client system; ii) generating a second referral message to the referral server, the second referral message including identification of the advertising merchant's web page and at least a second target client; iii) linking to an additional web page related to the advertising merchant's web page; and iv) posting information entered into data fields by the target client to the advertising merchant; and
initiate transfer the informational message to the accounting server; and
the accounting server being adapted to, in response to receipt of the informational message:
debit at least a referral fee from an account associated with the advertising merchant's web page; and
credit the referral fee to an account associated with the referral server providing the referral instruction.

2. The system of claim 1, wherein:
the revenue event comprises generating a second referral message to the referral server, the second referral message including identification of the advertising merchants web page and identification of at least a second target client;
the target referral module is further adapted to generate the second referral message to the referral server;
the referral server is further adapted to provide a second referral instruction to a second target client system, the second target client system being distinct from both the source client system and the target client system and being operated by the second target client, the second referral instruction comprising identification of the advertising merchant's web page; and
the second target client system comprising:
a second target referral module adapted to:
receive the second referral message and render a window prompting the second target client to one of accept and decline the referral message;
upon the second target client accepting the referral message, pass identification of the advertising merchant's web page to a second target web browser, the second target web browser rendering the advertising merchant's web page on the second target client system; and
generate a second informational message upon the execution of a revenue event by the second target client system, the revenue event being an event selected from a group of events consisting of: i) rendering the advertising merchant's web page on the second target client system; ii) generating a third referral message to the referral server, the third referral message including identification of the advertising merchant's web page and at least a third target client; iii) linking to an additional web page related to the advertising merchant's web page; and vi) posting information entered into data fields by the second target client to the advertising merchant; and
initiate transfer the informational message to the accounting server; and
the accounting server being further adapted to, in response to receipt of the second informational message:
debit at least a second referral fee from an account associated with the advertising merchant's web page; and
credit the second referral fee to an account associated with the referral server providing the referral instruction.

3. A system for monetizing the referral of a web pages, the system comprising:
a source client system operated by a first user; the source client system comprising:
a source web browser adapted to:
render a base web page;
render, within the base web page, an advertisement associated with an advertising merchant's web page, the advertisement being one of a paid listing within search results and advertisement content; and
in response to user selection of the advertisement, linking to a URL associated with the advertisement to obtain the advertising merchant's web page;
a referral module coupled to the web browser and being adapted to, in response to user selection of at least one target client, generate a referral message to a referral server, the referral message identifying at least one target client and the advertising merchant's web page;
a referral server adapted to provide a referral instruction to a target client system, the target client system being distinct from the source client system and being operated by one of the identified target clients, the referral instruction comprising identification of the advertising merchant's web page; and
an accounting server, the accounting server being adapted to:
receive an informational message, the informational message including an indication that the target client system has executed a revenue event, the revenue event being an event selected from a group of events consisting of: i) rendering the advertising merchant's landing page on the target client system; ii) generating a second referral message to the referral server, the second referral message including identification of the advertising merchant's landing page; iii) linking to an additional web page related to the advertising merchant's web page; and vi) posting information entered into data fields by the target client to a web server of the advertiser; and
in response to receipt of the informational message:
debit at least referral fee from an account associated with the advertisement impression; and
credit the referral fee to an account associated with the referral server providing the referral instruction.

4. The system of claim 3, further comprising the target client system, the target client system comprising:
a referral module adapted to:
receive the referral message and render a window prompting the target client to one of accept and decline the referral message;
upon the target client accepting the referral message, pass identification of the advertising merchant's web page to a target client system web browser;
upon the execution of the revenue event:
generate the informational message; and
initiate transfer the informational message to the accounting server.

5. The system of claim 3, wherein:
the source web browser is further adapted to, in response to the user selection of the advertisement, generate a click report to the accounting server; and
the accounting server is further adapted to:
in response to receipt of the click report:
debit at least a click fee from an account associated with the advertising merchant; and
credit the click fee an account associated with the base web page, the click fee being distinct from the referral fee.

6. A system for monetizing the referral of web pages, the system comprising:
an advertisement server adapted to:
maintain an index of at least two distinct advertisement classifications;
associate with each advertisement classification, at least one relevant advertisement;
upon receipt of a search request, the search request including a search query:
determining the advertisement classification to which the search query matches; and
return a relevant advertisement from the classification to which the search query matches as a paid listing within search results, the advertisement being one of a paid listing within search results and graphic advertisement content;
upon receipt of a click report,
debit at least a first click fee from an account associated with the relevant advertisement; and
credit the first click fee to an account associated with the advertisement server;
a source client system operated by a first user; the source client system comprising:
a web browser adapted to:
obtain user entry of the search query;
generate the search request to the advertisement server;
in response to receipt of search results, rendering the paid listing in combination with the search results;
in response to user selection of the paid listing:
generating the click report to the advertisement server; and
linking to a URL associated with the advertisement content to obtain the advertising merchant's landing page;
a referral module coupled to the web browser and being adapted to:
in response to user selection of at least one target client, generate a referral message to a referral server, the referral message identifying at least one target client and the advertising merchant's landing page;
a referral server adapted to:
provide a referral instruction to a target client system, the target client system being distinct from the source client system and being operated by one of the identified target clients, the referral instruction comprising identification of the referred web page; and
the advertisement server being further adapted to:
receive a referral informational message, the referral informational message including an indication that the target client system has executed a revenue event, the revenue event being an event selected from a group of events consisting of: i) rendering the advertising merchant's landing page on the target client system; ii) generating a second referral message to the referral server, the second referral message including identification of the advertising merchant's landing page; and iii) posting information entered into data fields by the target client to a web server of the advertiser; and
in response to receipt of the referral informational message:
debit at least a referral fee from the account associated with the relevant advertisement; and
credit the referral fee to an account associated with the referral server providing the referral instruction, the referral fee being distinct from the click fee.

7. The system of claim 6, further comprising the target client system, the target client system comprising:
a referral module adapted to:
receive the referral message and render a window prompting the target client to one of accept and decline the referral message;
upon the target client accepting the referral message, pass identification of the advertising merchant's landing page to a target client system web browser;
upon the execution of a reportable event:
generate an informational message, the informational message including identification of the advertisers website and identification of the reportable event; and
transfer the informational message to the referral server; and
wherein the referral server further comprises:
a database comprising a plurality of reportable event data sets, each revenue event dataset associating the indication of the advertising merchant's website and the identification of the revenue action; and
a reporting tool, the reporting good being adapted to generate a report comprising at least one informational message to the advertisement server, the informational message comprising, for at least one reportable event which is a revenue event, at least one reportable event dataset.

8. The system of claim 7, wherein the advertisement server is further adapted to:
in response to receipt of the informational message:
debit an additional fee from the account associated with the relevant advertisement; and
credit the additional fee to the account associated with the advertisement server, the additional fee being a fee distinct from the referral fee and being revenue for the operator of the advertisement server.

9. the system of claim 6, further comprising the target client system, the target client system comprising:
a referral module adapted to:
receive the referral message and render a window prompting the target client to one of accept and decline the referral message;
upon the target client accepting the referral message, pass identification of the advertising merchant's landing page to a target client system web browser;
upon the execution of the revenue event:
generate the informational message; and
transfer the informational message to the advertising server.

10. The system of claim 9, wherein the advertisement server is further adapted to:
debit an additional fee from the account associated with the relevant advertisement; and
credit the additional fee to the account associated with the advertisement server, the additional fee being a fee distinct from the referral fee and being revenue for the operator of the advertisement server.

11. A method of operating a source client system, at least one target client system, a referral server, and an accounting server system for monetizing the referral of a web pages, the method comprising:
rendering, by a web browser of the source client system, an advertising merchant's web page;
in response to user selection of at least one target client, generating a referral message to the referral server, the referral message identifying at least one target client and the advertising merchant's web page;
generating a referral instruction from the referral server to the target client system, the target client system being distinct from the source client system and being operated by one of the identified target clients, the referral instruction comprising identification of the advertising merchant's web page; and
in response to receipt of the referral message by the target client system, rendering a window prompting the target client to one of accept and decline the referral message;
upon the target client accepting the referral message, passing identification of the advertising merchant's web page to a target web browser, the target web browser rendering the advertising merchant's web page on the target client system; and
generating an informational message upon the execution of a revenue event by the target client system, the revenue event being an event selected from a group of events consisting of: i) rendering the advertising merchant's web page on the target client system; ii) generating a second referral message to the referral server, the second referral message including identification of the advertising merchant's web page and at least a second target client; iii) linking to an additional web page related to the advertising merchant's web page; and iv) posting information entered into data fields by the target client to the advertising merchant; and
initiating transfer the informational message to the accounting server; and
in response to receipt of the informational message by the accounting server:
debiting at least a referral fee from an account associated with the advertising merchant's web page; and
crediting the referral fee to an account associated with the referral server providing the referral instruction.

12. The method of claim 11:
wherein the revenue event comprises the target client system generating a second referral message to the referral server, the second referral message including identification of the advertising merchant's web page and identification of at least a second target client; and the method further comprises
generating the second referral message from the target client system to the referral server;
generating a second referral instruction from the referral server to a second target client system, the second target client system being distinct from both the source client system and the target client system and being operated by the second target client, the second referral instruction comprising identification of the advertising merchant's web page; and
receiving the second referral message at the target client system and rendering a window prompting the second target client to one of accept and decline the referral message;
upon the second target client accepting the referral message, passing identification of the advertising merchant's web page to a second target web browser, the second target web browser rendering the advertising merchant's web page on the second target client system; and
generating a second informational message upon the execution of a revenue event by the second target client system, the revenue event being an event selected from a group of events consisting of: i) rendering the advertising merchant's web page on the second target client system; ii) generating a third referral message to the referral server, the third referral message including identification of the advertising merchant's web page and at least a third target client; iii) linking to an additional web page related to the advertising merchant's web page; and vi) posting information entered into data fields by the second target client to the advertising merchant; and
initiate transfer the second informational message to the accounting server; and
in response to receipt of the second informational message by the accounting server:
debiting at least a second referral fee from an account associated with the advertising merchant's web page; and
crediting the second referral fee to an account associated with the referral server providing the referral instruction.

13. A method of operating a source client system, at least one target client system, a referral server and an accounting server for monetizing the referral of a web pages, the method comprising:
rendering a base web page by a web browser of the source client system;
rendering, within the base web page, an advertisement associated with an advertising merchant's web page, the advertisement being one of a paid listing within search results and advertisement content; and
in response to user selection of the advertisement, linking to a URL associated with the advertisement to obtain and render by the web browser, the advertising merchant's web page;
in response to user selection of at least one target client to initiate referral of the merchant's web page, generating a referral message to the referral server, the referral message identifying at least one target client and the advertising merchant's web page;
generating a referral instruction from the referral server to the target client system, the target client system being distinct from the source client system and being operated by one of the identified target clients, the referral instruction comprising identification of the advertising merchant's web page; and
receiving an informational message at the accounting server, the informational message including an indication that the target client system has executed a revenue event, the revenue event being an event selected from a group of events consisting of: i) rendering the advertising merchant's landing page on the target client system; ii) generating a second referral message to the referral server, the second referral message including identification of the advertising merchant's landing page; iii) linking to an additional web page related to the advertising merchant's web page; and vi) posting information entered into data fields by the target client to a web server of the advertiser; and
in response to receipt of the informational message:
debiting at least a referral fee from an account associated with the advertisement impression; and
crediting the referral fee to an account associated with the referral server providing the referral instruction.

14. The method of claim 13, further comprising, in response to receipt of the referral instruction by the target client system:
rendering a window prompting the target client to one of accept and decline the referral message;
upon the target client accepting the referral message, passing identification of the advertising merchant's web page to a target client system web browser; and
upon the execution of the revenue event:
generating the informational message; and
initiating transfer the informational message to the accounting server.

15. The method of claim 13:
further comprising, in response to the user selection of the advertisement, generate a click report from the source client system to the accounting server; and
in response to receipt of the click report by the accounting server:
debiting at least a click fee from an account associated with the advertising merchant; and
crediting the click fee an account associated with the base web page, the click fee being distinct from the referral fee.

16. A method of operating a source client system, at least one target client system, an advertisement server, a referral server and an accounting server for monetizing the referral of web pages, the method comprising:
obtaining, at the source client system, user entry of a search query;
generating a search request to the advertisement server, the search request including the search query;
maintaining, at the advertisement server, maintain an index of at least two distinct advertisement classifications;
associating, with each advertisement classification, at least one relevant advertisement;
upon receipt of a search request by the advertisement server:
determining the advertisement classification to which the search query matches; and
returning a relevant advertisement from the classification to which the search query matches, the advertisement being one of a paid listing within search results and graphic advertisement content;
in response to receipt of search results at the source client system, rendering the paid listing in combination with the search results;
in response to user selection of the advertisement:
generating the click report to the advertisement server; and
linking to a URL associated with the advertisement content to obtain the advertising merchant's web page;
upon receipt of a click report at the advertisement server:
debiting at least a first click fee from an account associated with the relevant advertisement; and
crediting the first click fee to an account associated with the advertisement server;
in response to user selection of at least one target client to initiate a referral of the advertising merchant's web page, generating a referral message to the referral server, the referral message identifying at least one target client and the advertising merchant's landing page;
generating a referral instruction from the referral server to the target client system, the target client system being distinct from the source client system and being operated by one of the identified target clients, the referral instruction comprising identification of the referred web page; and
receiving, at the advertisement server, an informational message, the informational message including an indication that the target client system has executed a revenue event, the revenue event being an event selected from a group of events consisting of: i) rendering the advertising merchant's landing page on the target client system; ii) generating a second referral message to the referral server, the second referral message including identification of the advertising merchant's landing page; and iii) posting information entered into data fields by the target client to a web server of the advertiser; and
in response to receipt of the informational message:
debiting at least a referral fee from the account associated with the relevant advertisement; and
crediting the referral fee to an account associated with the referral server providing the referral instruction, the referral fee being distinct from the click fee.

17. The method of claim 16, further comprising:
in response to receipt of the referral message at the target client system, rendering a window prompting the target client to one of accept and decline the referral message;
upon the target client accepting the referral message, passing identification of the advertising merchant's web page to a target client system web browser for rendering on the target client system;
upon the execution of a reportable event:
generating an informational message, the informational message including identification of the advertisers website and identification of the reportable event; and
transferring the informational message to the referral server; and
maintaining, at the referral server, a database comprising a plurality of reportable event data sets, each revenue event dataset associating the indication of the advertising merchant's website and the identification of the revenue action; and
generating a report comprising at least one informational message from the referral server to the advertisement server, the informational message comprising, for at least one reportable event which is a revenue event, at least one reportable event dataset.

18. The method of claim 17, further comprising, in response to receipt of the informational message:
debiting an additional fee from the account associated with the relevant advertisement; and
crediting the additional fee to the account associated with the advertisement server, the additional fee being a fee distinct from the referral fee and being revenue for the operator of the advertisement server.

19. The method of claim 16, further comprising:
in response to receipt of the referral message at the target client system, rendering a window prompting the target client to one of accept and decline the referral message;
upon the target client accepting the referral message, passing identification of the advertising merchant's web page to a target client system web browser for rendering on the target client system; and
upon the execution of the revenue event:
generating the informational message from the target client system; and
transferring the informational message from the target client system to the advertising server.

20. The system of claim 19, further comprising, in response to receipt of the informational message:
debiting an additional fee from the account associated with the relevant advertisement; and
crediting the additional fee to the account associated with the advertisement server, the additional fee being a fee distinct from the referral fee and being revenue for the operator of the advertisement server.
